(19) United States
(12) Patent Application Publication
(10) Pub. No.: US 2015/0127868 A1
(43) Pub. Date: May 7, 2015

(54) INFORMATION PROCESSING DEVICE, CONTROL METHOD, AND NON-TRANSITORY COMPUTER-READABLE RECORDING MEDIUM HAVING CONTROL PROGRAM RECORDED THEREON

(71) Applicant: FUJITSU LIMITED, Kawasaki-shi (JP)

(72) Inventors: Tetsuya Kamino, Kawasaki (JP); Masakazu Yabe, Setagaya (JP)

(21) Appl. No.: 14/597,256

(22) Filed: Jan. 15, 2015

Related U.S. Application Data
(63) Continuation of application No. PCT/JP2012/069548, filed on Aug. 1, 2012.

(51) Int. Cl. G06F 13/40; G06F 13/42

(52) U.S. Cl. CPC G06F 13/404; G06F 13/4221
USPC 710/306

(57) ABSTRACT

An information processing device creates a management table of bridge addresses by allocating the bridge addresses to a plurality of bridges, respectively, and, when detecting one access to one device of a plurality of devices, refers to the management table, performs, based on the management table referred to, cancelling allocation of a bridge address of the bridge addresses and reallocating the bridge address to one or more of the plurality of bridges to enable execution of the one access, and updates the management table in regard to the bridge address cancelled and reallocated. Consequently, the information processing device can simultaneously use bridges the number of which exceeds a predetermined number even when the bridges the number of which exceeds the predetermined number are provided in the information processing device and therefore bridge addresses run out.

### CROSS-REFERENCE TO RELATED APPLICATION

This application is a continuation application of International Application PCT/JP2012/069548 filed on Aug. 1, 2012 and designated the U.S., the entire contents of which are incorporated herein by reference.

### FIELD

The present invention relates to an information processing device, a control method and a non-transitory computer-readable recording medium having a control program recorded thereon.

### BACKGROUND

In a computer system of a general architecture, a CPU (Central Processing Unit) is connected to a memory and a chip set and can access a PCI device (referred to as a device below) connected to PCI (Peripheral Components Interconnect) Express buses through a host bridge. Expansion cards such as a RAID (Redundant Arrays of Inexpensive Disks) card and a SAS (Serial Attached SCSI (Small Computer System Interface)) card can be added to PCI Express slots (referred to as slots below). The expansion cards are connected to the host bridge of the chip set through a switch which mutually connects the PCI express buses. The switch has a built-in PCI bridge (referred to as a bridge).

In recent years, a method of operating a control program as a hypervisor for server integration and the like, and operating a plurality of virtual servers on one physical calculator is spreading. An application operating on an OS (Operation System) on a virtual server accesses a device through a library of the OS including a driver and the like. The device is accessed using a memory mapped I/O (MMIO) access or I/O addresses (I/O space addresses). In recent years, an access using I/O addresses is called a legacy method and a MMIO access is a main stream. However, there are still devices which request I/O addresses. Such devices are not able to be used when I/O addresses are not allocated.

I/O space addresses are allocated to a device by a BIOS (Basic Input Output System) and the library of the OS accesses the device using the allocated I/O space addresses. In the computer system, the BIOS is executed upon activation, I/O addresses are allocated and the devices are initialized. The BIOS checks all devices by a PCI bus scan which is an existing technique, and allocates I/O addresses to each device. A range of I/O addresses is allocated to a bridge for a device connected to a bus under the bridge, and the I/O address in the range allocated to the bridge is allocated to the device connected to the bus under the bridge. When a virtual server is operated, after a process in the BIOS, the hypervisor is operated, virtual servers are created, virtual server configuration information including information as to which device which virtual server is allocated, i.e., correspondence information between an I/O address of each virtual server and an I/O address of the hypervisor is created, and the hypervisor activates a virtual server.

As illustrated in FIG. 32, a device access (I/O access) from each virtual server is trapped by the hypervisor and sequentially processed (steps S1 and S2). The hypervisor performs a conversion process between I/O spaces of a virtual server and an actual server based on the virtual server configuration information. When a device is allocated to a virtual server, the hypervisor accesses this device (step S3), and returns this access result to the virtual server (step S4). When a virtual device is allocated instead of an actually existing device (referred to as an actual device below), the hypervisor processes an access to the virtual device and returns the process result to the virtual server.

Patent Document 1 (JP 2003-337788 A) discloses a technique of efficiently allocating I/O addresses. The technique efficiently uses I/O addresses by allocating addresses of the same range to two or more PCI bridges such that collision does not occur.

Further, Patent Document 2 (JP 2010-39760 A) discloses a technique of handling virtual servers. The technique prevents an I/O resource mismatch caused when a hot plug of a device or a virtual server is dynamically reconfigured, by uniquely allocating a number to a virtual bridge in an I/O switch and allocating I/O resources based on this number.

According to a specification defined by a PCI-to-PCI Bridge Architecture Specification (referred to as a PCI specification), addresses are allocated to bridges in units of 4 KB. A general CPU has I/O spaces of, for example, only 64 KB, and a head 4 KB is reserved by the system. Hence, as illustrated in FIG. 33, at a point of time when 15 bridges #1 to #15 connected to devices #1 to #30 which request I/O spaces are allocated, I/O spaces run out, and an I/O address cannot be allocated to a 16th bridge #16. Therefore, there is a problem that 16 or more bridges cannot be simultaneously used. The slots are connected to the bridges, and therefore the number of devices to be added through the slots is 15 at maximum.

Further, in recent years, as described above, server integration for operating a plurality of virtual servers on one physical calculator and reducing cost is carried out. Virtual servers are allocated devices on a physical calculator and used. However, bridges which one physical calculator can recognize are restricted as described above. Therefore, there is a problem that, when a plurality of virtual servers is operated, sufficient devices are not able to be allocated to one virtual server.

According to Patent Document 1, it is possible to allocate multiple devices yet dedicated host bus bridges are used. Further, allocating I/O addresses to a host bus does not comply with the PCI specification.

According to Patent Document 2, I/O resource IDs (IDentification) are determined for respective bridges in advance, and the I/O resource IDs (I/O addresses) are not allocated to devices connected to bridges which are not included in a predetermined number.

### SUMMARY

According to one idea, an information processing device includes a processor, a plurality of devices, a plurality of bridges which connects the processor and the plurality of devices, a creator and an allocator. The creator creates a management table managing bridge addresses allocated to the plurality of bridges, and, when an unallocated bridge address to be allocated to one bridge of the plurality of bridges runs out, cancels allocation of a first bridge address of the bridge addresses allocated to another bridge of the plurality of bridges, reallocates the cancelled first bridge address to the one bridge, and updates the management table in regard to the first bridge address cancelled and reallocated. When detecting one access to one device of the plurality of devices, the allocator refers to the management table, performs, based on the management table referred to, cancelling allocation of a second bridge address of the bridge addresses and reallocating the second bridge address to one or more of the plurality of bridges to enable execution of the one access, and updates the management table in regard to the second bridge address cancelled and reallocated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a block diagram that illustrates a configuration of an information processing device according to a first embodiment.

FIG. 2 illustrates a view illustrating a configuration of a configuration register included in a PCI bridge.

FIG. 3 illustrates a block diagram that illustrates an example of a specific configuration including I/O address allocation targets (PCI devices and PCI bridges) in the information processing device illustrated in FIG. 1.

FIG. 4 illustrates a view that illustrates an example of a correspondence table (management table) created for the configuration illustrated in FIG. 3.

FIG. 5 is a flowchart that explains a correspondence table creation process in the information processing device (creator) illustrated in FIG. 1.

FIG. 6 is a flowchart that explains a bus setting process in the correspondence table creation process illustrated in FIG. 5.

FIG. 7 is a flowchart that explains an I/O setting process in the correspondence table creation process illustrated in FIG. 5.

FIG. 8A illustrates a block diagram that illustrates another example of a specific configuration including I/O address allocation targets in the information processing device illustrated in FIG. 1, and a state after a bus setting process of the configuration.

FIG. 8B illustrates a view that illustrates a default state of the correspondence table created for the configuration illustrated in FIG. 8A.

FIG. 9A illustrates a block diagram that explains an I/O setting process.

FIG. 9B illustrates a view that illustrates a state where the correspondence state is created for the configuration illustrated in FIG. 9A.

FIG. 10A illustrates a block diagram that explains the I/O setting process.

FIG. 10B illustrates a view that illustrates a state where the correspondence state is created for the configuration illustrated in FIG. 10A.

FIG. 11A illustrates a block diagram that explains the I/O setting process.

FIG. 11B illustrates a view that illustrates a state where the correspondence state is created for the configuration illustrated in FIG. 11A.

FIG. 12A illustrates a block diagram that explains the I/O setting process.

FIG. 12B illustrates a view that illustrates a state where the correspondence state is created for the configuration illustrated in FIG. 12A.

FIG. 13A illustrates a block diagram that explains the I/O setting process.

FIG. 13B illustrates a view that illustrates a state where the correspondence state is created for the configuration illustrated in FIG. 13A.

FIG. 14A illustrates a block diagram that explains the I/O setting process.

FIG. 14B illustrates a view that illustrates a state where the correspondence state is created for the configuration illustrated in FIG. 14A.

FIG. 15 is a flowchart that explains an I/O access process in the information processing device (allocator) illustrated in FIG. 1.

FIGS. 16 to 19 illustrate views that illustrate specific correspondence tables for explaining the I/O access process illustrated in FIG. 15.

FIG. 20A illustrates a block diagram that explains the I/O access process illustrated in FIG. 15.

FIG. 20B illustrates a view that illustrates a state of the correspondence table corresponding to the process illustrated in FIG. 20A.

FIG. 21A illustrates a block diagram that explains the I/O access process illustrated in FIG. 15.

FIG. 21B illustrates a view that illustrates a state of the correspondence table corresponding to the process illustrated in FIG. 12A.

FIG. 22 illustrates a block diagram that illustrates a configuration of an information processing device according to a second embodiment.

FIG. 23 illustrates a sequence diagram that specifically explains a process in the information processing device illustrated in FIG. 22.

FIG. 24 is a flowchart that explains a process in the information processing device illustrated in FIG. 22.

FIG. 25 is a flowchart that explains a correspondence table creation process in the information processing device (creator) illustrated in FIG. 22.

FIGS. 26 and 27 illustrate views that explain a process in case where bridge addresses run out in the correspondence table creation process illustrated in FIG. 25.

FIG. 28 is a flowchart that explains an address allocation process in the information processing device (allocator) illustrated in FIG. 22.

FIG. 29 illustrates a view that explains a process in case where an access target device belongs to an address unallocated bridge in the address allocation process illustrated in FIG. 28.

FIG. 30 illustrates a block diagram that illustrates a configuration of an information processing device according to a third embodiment.

FIG. 31 illustrates a sequence diagram that specifically explains a process in the information processing device illustrated in FIG. 30.

FIG. 32 is a flowchart that explains a flow of a process of a devices access from a virtual server.

FIG. 33 illustrates a view that illustrates an example of allocation of addresses to a bridge based on a PCI specification (a state where bridge addresses run out).

### DESCRIPTION OF THE PREFERRED EMBODIMENTS

Embodiments will be described with reference to the drawings.

[1] Information Processing Device According to First Embodiment

[1-1] Configuration According to First Embodiment

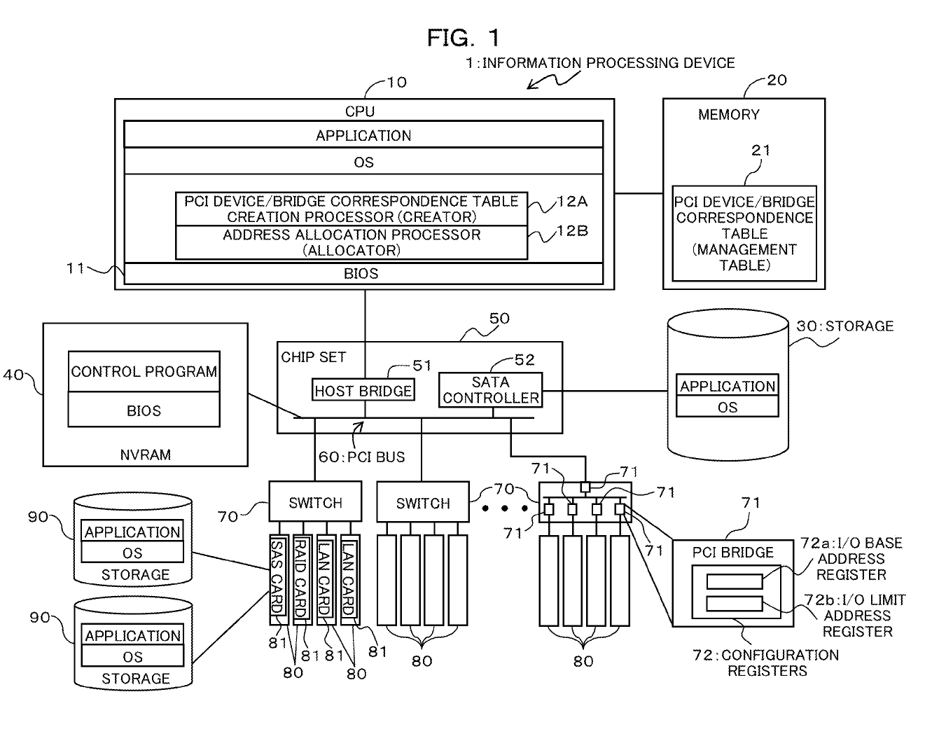

FIG. 1 illustrates a block diagram that illustrates a configuration of an information processing device (computer system) 1 according to the first embodiment. The computer system 1 illustrated in FIG. 1 has a CPU (processor) 10, a memory 20, a storage 30, a NVRAM (Non-Volatile Random Access Memory) 40, a chip set 50, PCI buses 60, switches 70, slots 80 and storages 90.

The NVRAM 40 stores a BIOS (Basic Input/Output System) program which causes the CPU 10 to initialize the computer system 1. The CPU 10 activates a BIOS 11 by executing the BIOS program. Further, the NVRAM 40 stores a control program which causes the CPU 10 to function as a PCI device/bridge correspondence table creation processor 12A and an address allocation processor 12B described below.

The storage 30 stores an OS and application programs for the CPU 10.

In the memory 20, the BIOS program read from the NVRAM 40 and the OS and the application programs read from the storage 30 by the CPU 10 are expanded and stored. Further, the memory 20 stores a PCI device/bridge correspondence table 21 described below.

The chip set 50 is connected to the CPU 10, the storage 30 and the NVRAM 40, and is connected to a plurality of PCI-Ex (Express) slots (simply referred to as slots below) 80 through the PCI buses 60 and the switches 70. The chip set 50 has a host bridge 51 and a SATA (Serial Advanced Technology Attachment) controller 52. The SATA controller 52 controls an access to the storage 30 according to a request from the CPU 10. The host bridge 51 connects the storage 30, the NVRAM 40 and the slots 80 to the CPU 10.

SAS cards, RAID (Redundant Arrays of Inexpensive Disks) cards and LAN (Local Area Network) cards are inserted as PCI devices (simply referred to as devices; expansion cards) 81 to the slots 80. It is possible to add the storages 90 by inserting SAS cards as the devices 81. The device 81 inserted in the slot 80 is connected to the host bridge 51 through the PCI bridge (simply referred to as a bridge) 71 built in the switch 70 which mutually connects the PCI buses 60.

The computer system 1 has a plurality of switches 70, and each switch 70 illustrated in FIG. 1 is connected with the four slots 80. Each switch 70 has, for example, the five bridges 71. One end side of one bridge 71 of the five bridges 71 is connected with the host bridge 51 through the PCI bus 60. The other end side of the one bridge 71 is connected with one end sides of the rest of the four bridges 71 through the PCI buses 60. The other end sides of the four bridges 71 are connected with the slots 80 through the PCI buses 60, respectively. In addition, a SAS card, a RAID card and two LAN cards are inserted as the devices 81 to the slots 80 connected to the four bridges 71 in the switch 70 on the left side in FIG. 1. The devices 81 (not illustrated) are also inserted to the slots 80 connected to the switches 70 other than the switch 70 on the left side in FIG. 1.

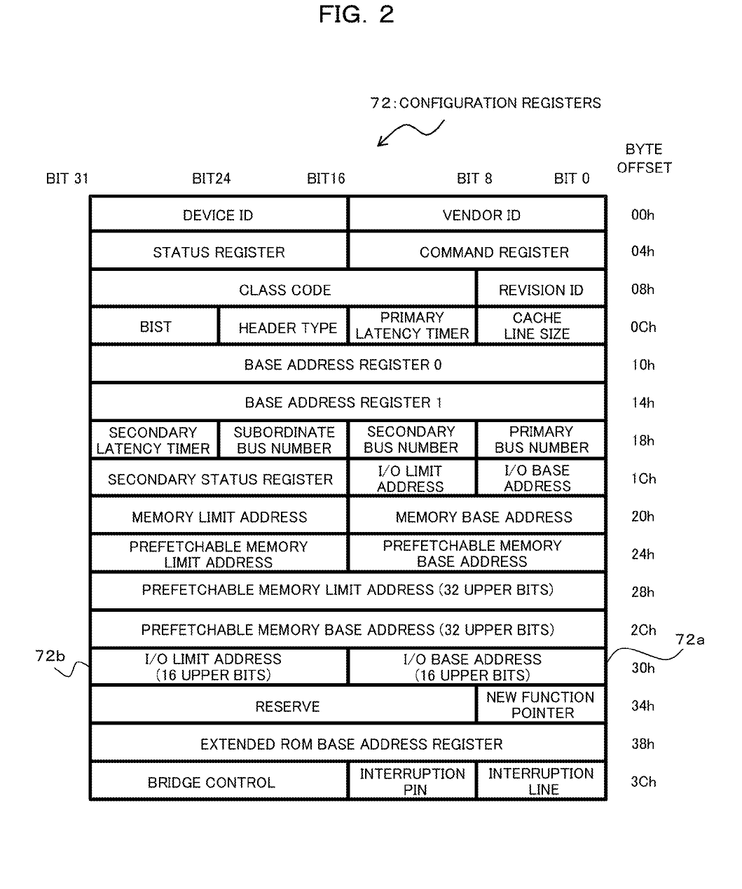

Each bridge 71 has a configuration register (bridge control register) 72 which sets a state of the bridge 71. As illustrated in FIG. 2, the configuration register 72 includes an I/O base address register (base address register) 72a and an I/O limit address register (limit address register) 72b. In addition, FIG. 2 illustrates a view that illustrates a configuration of the configuration register 72 included in the bridge 71.

The PCI device/bridge correspondence table creation processor 12A or the address allocation processor 12B described below sets to the I/O base address register 72a a lower limit value of an I/O address range to be allocated to the bridge 71. The PCI device/bridge correspondence table creation processor 12A or the address allocation processor 12B described below sets to the I/O limit address register 72b an upper limit value of the I/O address range to be allocated to the bridge 71.

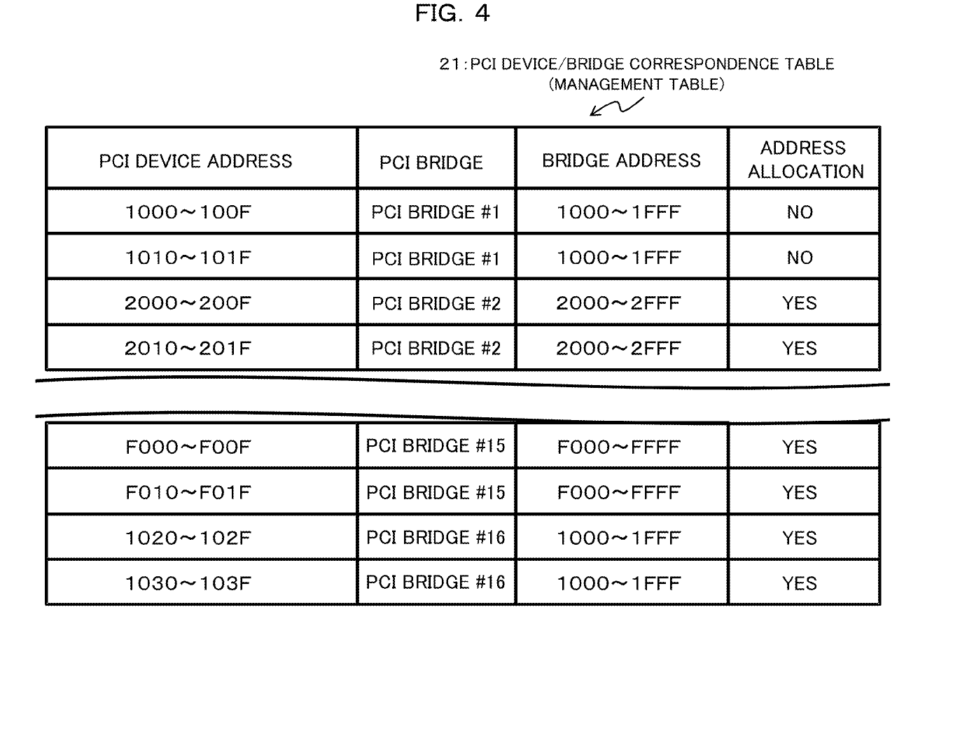

That is, the PCI device/bridge correspondence table creation processor 12A or the address allocation processor 12B allocates bridge addresses (see, for example, FIG. 4) to the bridge 71 by setting address values (a lower limit value and an upper limit value) for specifying a bridge address range, to the I/O base address register 72a and the I/O limit address register 72b. Further, the PCI device/bridge correspondence table creation processor 12A or the address allocation processor 12B cancels allocation of the bridge addresses to the bridge 71 by setting 0 to the I/O base address register 72a and the I/O limit address register 72b, respectively. By canceling the allocation, the bridge 71 stops transferring the I/O access to lower buses.

The CPU 10 functions as the PCI device/bridge correspondence table creation processor 12A and the address allocation processor 12B by executing the control program read from the NVRAM 40 after the computer system 1 is activated. In addition, the PCI device/bridge correspondence table creation processor 12A will be simply referred to as the creator 12A, and the address allocation processor 12B will be simply referred to as the allocator 12B in some cases.

The PCI device/bridge correspondence table creation processor 12A is invoked during an initialization process (PCI bus scan) upon activation of the computer system 1, and performs a process of creating the PCI device/bridge correspondence table 21 for all devices 81 and bridges 71. Hereinafter, the PCI device/bridge correspondence table 21 will be simply referred to as the correspondence table 21 in some cases.

The creator 12A creates the management table 21 managing bridge addresses while allocating bridge addresses to each of a plurality of bridges 71. In this regard, when unallocated bridge addresses to be allocated to one bridge of a plurality of bridges 71 run out, the creator 12A cancels allocation of the allocated bridge addresses which have been allocated to another bridge of a plurality of bridges 71. Further, the creator 12A allocates the bridge addresses to the one bridge, and updates the correspondence table 21 in regard to the allocated bridge addresses cancelled and reallocated.

The allocator 12B refers to the correspondence table 21 when detecting one access from the CPU 10 to one device of a plurality of devices 81. Further, the allocator 12B cancels allocation of bridge addresses and reallocates the bridge addresses to a plurality of bridges 71 to enable the one access, and updates the correspondence table 21 in regard to the bridge addresses cancelled and reallocated.

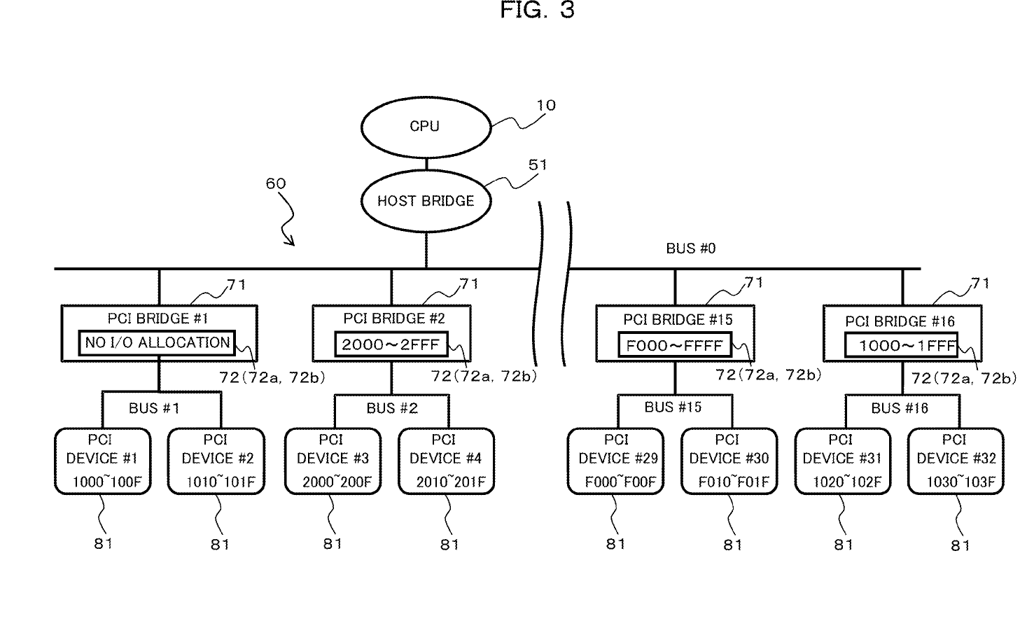

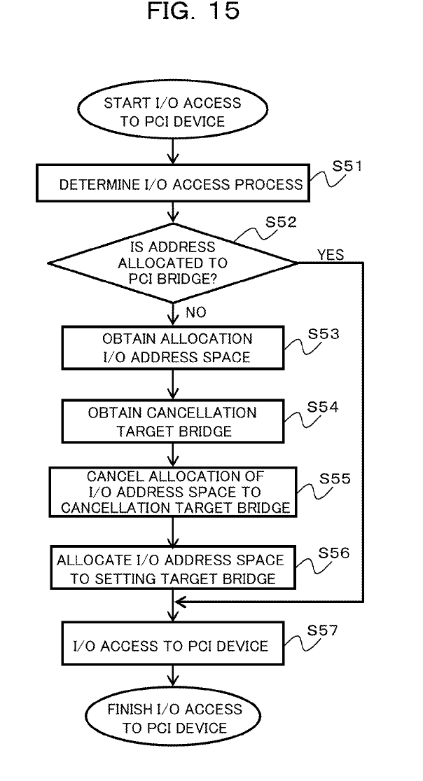

In this regard, in the present embodiment, too, addresses are allocated to bridges in units of 4 KB according to the PCI specification. Further, the I/O spaces of, for example, only 64 KB are prepared, and head 4 KB is reserved by the system. Hence, at a point of time when 15 (predetermined number) bridges #1 to #15 are allocated, bridge addresses in the I/O spaces run out. In the present embodiment, as described below in detail, the allocator 12B performs an I/O access process (address allocation process) using the correspondence table 21 created by the creator 12A. Consequently, even when (sixteen or more) bridges 71 the number of which exceeds the predetermined number are provided and therefore bridge addresses run out, it is possible to simultaneously use the bridges 71 the number of which exceeds the predetermined number. In addition, the process of creating the correspondence table 21 in the PCI device/bridge correspondence table creator 12A will be more specifically described with reference to FIGS. 3 to 14B. Further, the I/O access process (address allocation process) in the address allocation processor 12B will be more specifically described with reference to FIGS. 15 to 21B.

[1-2] Configuration of Correspondence Table

A configuration of the correspondence table (management table) 21 created by the PCI device/bridge correspondence table creator 12A will be described with reference to FIGS. 3 and 4. In addition, FIG. 3 illustrates a block diagram that illustrates an example of a specific configuration including I/O address allocation targets (the PCI devices 81 and the PCI bridges 71) in the information processing device 1 illustrated in FIG. 1. Further, FIG. 4 illustrates a view that illustrates an example of the correspondence table 21 created for the configuration illustrated in FIG. 3.

In the example of the specific configuration illustrated in FIG. 3, the 16 PCI bridges 71 are connected to the host bridge 51 connected to the CPU 10 through the PCI bus 60 (bus #0). Each bridge 71 has the configuration register 72, and I/O addresses are set to or cancelled for the bridge 71 using the I/O base address register 72a and the I/O limit address register 72B in the configuration register 72. In addition, the PCI bridges #1 to #16 indicating identification information (IDs; device numbers of bridge devices) for identifying the bridges 71 are used as reference numeral indicating bridges to specify one of a plurality of bridges, and reference numeral 71 is used to indicate an arbitrary bridge.

Further, each bridge 71 is connected with the two PCI devices 81 through the PCI buses 60 (#1 to #16). That is, two PCI devices #2i−1 and #2i are connected to a PCI bridge #i (i=1 to 16) through a bus #i. Hence, in the example illustrated in FIG. 3, 32 PCI devices #1 to #32 are provided. In addition, the PCI bridges #1 to #32 indicating identification information (IDs) for identifying the devices 81 are used as reference numerals indicating devices to specify one of a plurality of devices, and reference numeral 81 is used to indicate an arbitrary device. Further, the buses #0 to #16 indicate bus numbers for specifying the PCI buses 60, and are allocated by executing a PCI bus scan in the initialization process upon system activation.

The correspondence table 21 created by the creator 12A for the configuration illustrated in FIG. 3 employs, for example, a configuration illustrated in FIG. 4. That is, the creator 12A creates the correspondence table 21 by allocating different device addresses to each of a plurality of devices 81 and allocating bridge addresses to each of a plurality of bridges 71 when performing the initialization process upon system activation. In this regard, as illustrated in FIG. 4, the creator 12A creates a row (one record) per I/O address space allocated to each PCI device 81 in the correspondence table 21. Each row includes information described in following items (a1) to (a4).

(a1) An I/O address (PCI device address field) allocated to each PCI device 81

(a2) An identification name (bridge identification information; PCI bridge field) of a PCI bridge which specifies the bridge (a bridge through which a device access is made) 71 to which each device 81 belongs

(a3) An I/O address space (bridge address range; bridge address field) allocated to the bridge 71 specified based on the identification name of item (a2)

(a4) An address allocation flag (allocation information; address allocation field) indicating whether or not the bridge address of item (a3) is valid in the bridge 71 specified based on the identification name of item (a2)

In addition, the bridge 71 can be identified based on a device number of a bridge device when seen from the host bridge 51 and, consequently, can use the device number as the identification name of the bridge 71 of item (a2). Further, when a device access is made through a plurality of bridges 71, the bridges 71 directly under the host bridge 51 are targets to be registered in the correspondence table 21.

The I/O address space to be allocated to the bridge 71 in item (a3) refers to an I/O address space set to a PCI bus bridge upon initialization of the PCI buses 60, i.e., upon a PCI bus scan. When I/O address spaces run out during creation of the correspondence table 21, the creator 12A allocates overlapping I/O addresses to a plurality of bridges 71. In the example illustrated in FIG. 3, the same overlapping I/O address spaces 1000 to 1FFF are allocated the PCI bridge #1 and the PCI bridge #16. In this case, the creator 12A enables only one of these bridges #1 and #16, and cancels allocation of an I/O address space to the other bridge.

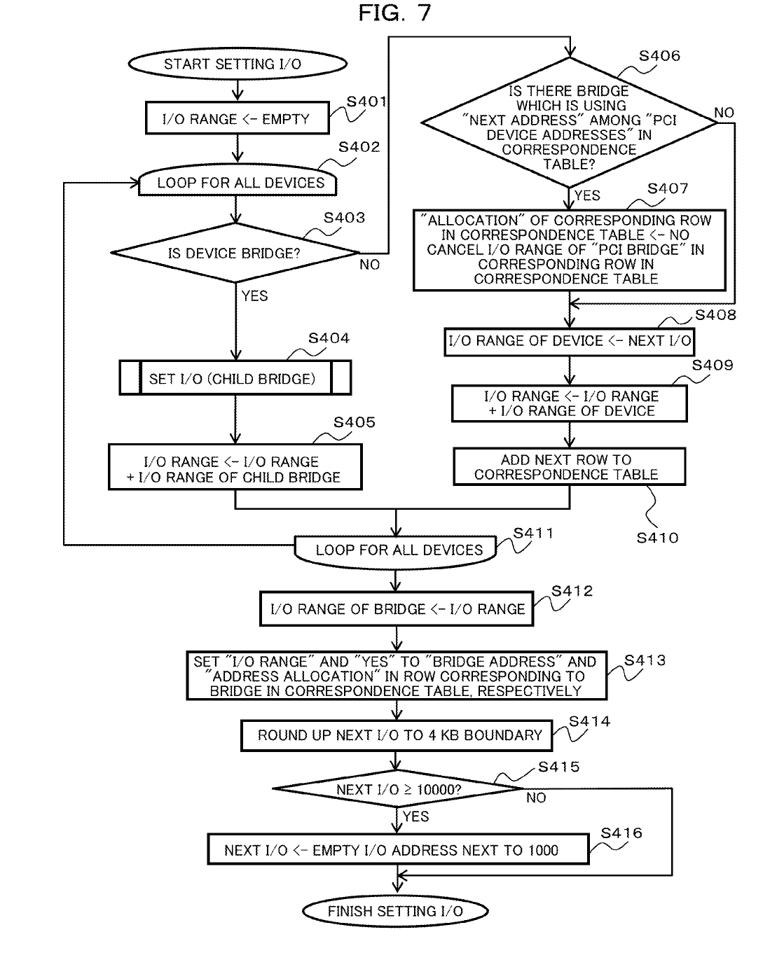

That is, as illustrated in FIG. 3, when unallocated bridge addresses to be allocated to the bridge #16 (one bridge) run out, the creator 12A cancels allocation of the allocated bridge addresses 1000 to 1FFF to the bridge #1 (the other bridge) and allocates the bridge addresses to the bridge #16. Further, as illustrated in FIG. 4, the creator 12A sets “no (invalid)” to an address allocation field corresponding to the bridge #1 for which address allocation has been canceled in the correspondence table 21, and sets “yes (valid)” to an address allocation field corresponding to the enabled bridge #16. In addition, a process in case where I/O address spaces run out and therefore I/O addresses cannot be allocated to all bridges 71 will be described in more detail later with reference to FIGS. 7 and 12A to 14B.

In this regard, allocation of I/O address spaces to the bridges 71 will be described. The bridge 71 functions to connect one upper PCI bus 60 to a lower PCI bus group. When the upper PCI bus 60 requests an I/O access, whether or not to transfer this request to the lower buses 60 is determined based on I/O address space set to the bridge 71. That is, when access target I/O addresses are included in the I/O address space set to the bridge 71, the bridge 71 transfers an I/O access from the upper bus 60 to the lower PCI bus 60. Further, when the lower bus 60 includes the PCI device 81 corresponding to the I/O address, this device 81 processes the I/O access.

As illustrated in FIGS. 1 to 3, the bridge 71 includes the configuration register 72 including the I/O base address register 72a and the I/O limit address register 72b. Further, as described above, the creator 12A or the allocator 12B sets a lower limit value and an upper limit value of a setting range to the I/O base address register 72a and the I/O limit address register 72b to allocate an I/O address space to each bridge 71. Furthermore, the creator 12A or the allocator 12B sets 0 to these registers 72a and 72b, so that allocation of I/O address spaces to the bridges 71 is canceled and the bridges 71 stop transferring I/O accesses from the upper buses 60 to the lower buses 60.

[1-3] Creation of Correspondence Table

The PCI device/bridge correspondence table creation processor 12A creates the correspondence table 21 by allocating I/O addresses to the PCI devices 81. An outline of the process of creating the correspondence table 21 will be described below.

In the process of creating the correspondence table 21, bus numbers of all PCI bridges 71 are initialized. At this point of time, the correspondence table 21 is initialized to an empty state.

Next, by performing a depth-first search for the PCI buses 60, the PCI devices 81 and the PCI bridges 71 are retrieved, and I/O address spaces of the PCI devices 81 and the PCI bridges 71 are set. When the PCI device 81 is detected, an I/O address space is set and a row for describing the device 81 is added to the correspondence table 21. A sum set of I/O address spaces of all devices 81 under the bridge 71 is set to an I/O address range of the bridge 71.

When I/O spaces to be allocated to the bridges 71 or the devices 81 become insufficient, the creator 12A initializes allocation addresses of I/O spaces to default values (0x1000) and continues the process. In this regard, an address 0x1000 has already been allocated to another device 81, and therefore the creator 12A uses an I/O address which is a second available to the address 0x1000. Further, the creator 12A refers to the “bridge address” field and the “address allocation” field of the correspondence table 21, and retrieves the bridge 71 to which the I/O address has been allocated. Allocation of the I/O address space to this bridge 71 is initialized to a default value (unallocated state), and “no” is set to the “address allocation” field of the correspondence table 21.

For example, in above FIGS. 3 and 4, the creator 12A uses up I/O addresses at a stage at which an I/O address space is allocated to the bridge #15, and I/O addresses to be allocated to the devices #31 and #32 under the bridge #16 become insufficient. In this case, the next I/O address is 0x1020 which is the first unallocated address after 0x1000. The creator 12A determines that the bridge 71 to which the address 0x1020 is allocated is the bridge #1 by referring to the “bridge address” field of the correspondence table 21. Further, the creator 12A resets (cancels) allocation of the I/O address space to the bridge #1, and sets “no” to the “address allocation” field of the correspondence table 21, too. Next, the creator 12A allocates addresses 0x1020 to 0x102F to the PCI device #31 and allocates addresses 0x1030 to 0x103F to the PCI device #32, then allocates 0x1000 to 0x1FFF to the registers 72a and 72b of the bridge #16, and sets “yes” to the “address allocation” field of the correspondence table 21.

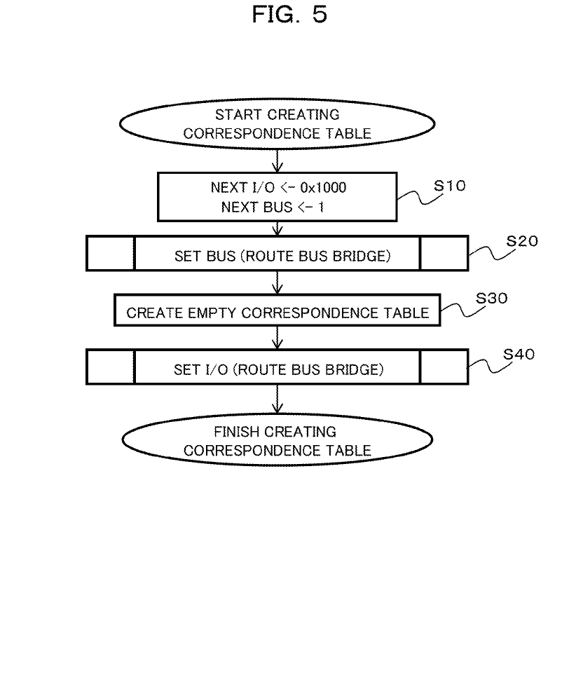

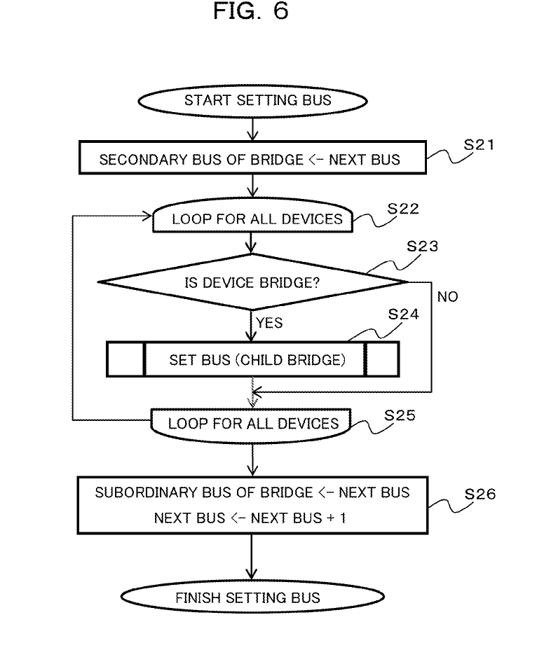

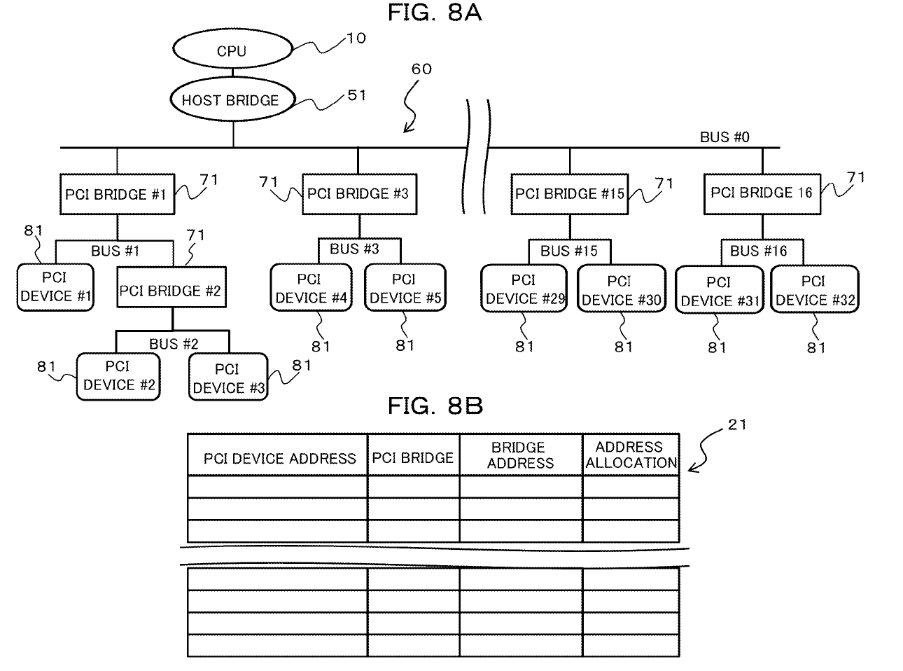

Then, the process of creating the correspondence table 21 in the PCI device/bridge correspondence table creation processor 12A will be described in detail according to the flowcharts illustrated in FIGS. 5 to 7 and with reference to FIGS. 8 to 14B. In this regard, FIG. 5 is a flowchart (steps S10 to S40) that explains the process of creating the correspondence table 21 in the creator 12A of the information processing device 1 illustrated in FIG. 1. FIG. 6 is a flowchart (steps S21 to S26) that explains a bus setting process (step S20) in the process of creating the correspondence table 21 illustrated in FIG. 5. FIG. 7 is a flowchart (steps S401 to S416) that explains an I/O setting process (step S40) in the process of creating the correspondence table 21 illustrated in FIG. 5.

In addition, FIGS. 3 and 4 illustrate a configuration of only one layer of the bridges 71. The process of creating the correspondence table 21 in a configuration where the bridge #1 and the bridge #2 are hierarchically provided will be described with reference to FIGS. 8A to 14B. That is, the bridge #1 is connected with the device #1 and the bridge #2 through the bus #1, and the bridge #2 is connected with the two devices #2 and #3 through the bus #2. Further, the bridge #3 is connected with the two devices #4 and #5 through the bus #3, the bridge #15 is connected with the two devices #29 and #30 through the bus #15, and the bridge #16 is connected with the two devices #31 and #32 through the bus #16.

In the correspondence creation process in the creator 12A, two variables of a next I/O and a next bus are used. The next I/O indicates an I/O address to be allocated to the next device 81, and the next bus indicates a bus number to be allocated to the next PCI bus 60 and is held in, for example, the memory 20. A default value of the next I/O is set to 0x1000, and a default value of the next bus is set to 1. The default values are set upon start of the correspondence table creation process (step S10 in FIG. 5).

After the default values are set, the creator 12A executes a bus setting subroutine (steps S21 to S26 in FIG. 6) (step S20 in FIG. 5). The bus setting subroutine specifies the bus bridge 71 as an argument. More specifically, a bus number and a device number of the bus bridge 71 are specified. The bus number and the device number of the bus bridge 71 are collectively described as a bridge or a route bus bridge in the drawings. The bus bridge 71 connects the upper bus (primary bus) 60 and the lower buses (secondary_bus) 60. Generally, there is a plurality of lower buses 60 of the bus bridge 71, a subordinary bus number “subordinary_bus” is specified in addition to a secondary bus number “secondary_bus”. Buses to which bus numbers satisfying the following condition are allocated are lower buses.

“secondary_bus”≦bus number<“subordinary_bus”

The bus setting subroutine first sets a value (bus number) of a “next bus” to “secondary_bus” of the specified bridge 71 (step S21). In the bus setting subroutine, the creator 12A sets a range of bus numbers of lower buses to the bridge 71 by allocating bus numbers to all buses under a bridge (steps S22 to S25 in FIG. 6), and setting the “next bus” to “subordinary_bus” of the bridge 71 (step S26 in FIG. 6). The creator 12A prevents bus numbers to be allocated to the next bus bridge 71 from overlapping by incrementing the value of the “next bus” by one (step S26 in FIG. 6) after finishing setting the bridge 71. The bus setting subroutine retrieves all devices 81 directly under the specified bridge 71 (steps S22 to S25 in FIG. 6). That is, the bus setting subroutine retrieves devices of the devices numbers #0 to #31 above the lower buses (secondary buses) of the bridge 71 (steps S22 to S25). Every time a device retrieved in this way is a bridge (YES route in step S23), the creator 12A recursively invokes the bus setting subroutine, and sets a bus number on a depth-first basis (step S24). FIG. 8A illustrates a state where setting the bus numbers #0 to #16 is finished. In this regard, FIG. 8A illustrates a block diagram that illustrates another example of a specific configuration including an I/O address allocation target in the information processing device 1 illustrated in FIG. 1, and illustrating a state of the configuration after the bus setting process. As described above, the configuration illustrated in FIG. 8A hierarchically has the bridge #1 and the bridge #2 unlike the configuration illustrated in FIG. 3.

Subsequently, as illustrated in FIG. 8B, the creator 12A creates the empty correspondence table 21 (step S30 in FIG. 5). FIG. 8B illustrates a view that illustrates a default state of the correspondence table 21 created for the configuration illustrated in FIG. 8A. The correspondence table 21 illustrated in FIG. 8B includes default values of the correspondence table 21.

Next, the creator 12A executes the I/O setting subroutine (steps S401 to S416 in FIG. 7) (step S40 in FIG. 5). The I/O setting subroutine is executed by specifying the bridge 71, and simultaneously allocates I/O address spaces to the PCI bridge 71 and the PCI devices 81 under the specified bridge and finishes up the correspondence table 21. The I/O setting subroutine holds an I/O range (I/O address range) as a local variable (I/O range variable) in, for example, the memory 20. This local variable indicates an I/O range allocated to a specified bridge and a device group under the specified bridge. The creator 12A first sets an empty set as a default value of the I/O range (step S401).

The creator 12A checks all devices directly under the specified bridge (steps S402 to S411) and, when a device is a bridge (YES route in step S403), recursively invokes the I/O setting subroutine (step S404) and allocates I/O address spaces to child bridges. Subsequently, the creator 12A adds I/O address spaces currently allocated to the child bridges, to the I/O range variable (step S405). Meanwhile, when a device is a PCI device (NO route in step S403), the creator 12A simultaneously allocates an I/O address space to the PCI device and adds a row corresponding to the PCI device, to the correspondence table 21 (steps S406 to S410). The process in steps S406 to S410 will be described in detail later. In addition, when a device is a PCI device, too, the creator 12A adds an I/O address space currently allocated to the PCI device, to the I/O range variable which is a local variable (step S409).

After a process of all devices (steps S402 to S411) is finished, the creator 12A sets the I/O range variable to an I/O range (registers 72a and 72b) of the specified bridge (step S412). Further, the creator 12A checks the PCI bridge field of the correspondence table 21, sets the “I/O range” to the bridge address field in the row corresponding to the specified bridge, sets “yes” to the address allocation field of the same row and finishes up the correspondence table 21 (step S413).

In the present embodiment, an I/O address space set to the bridge 71 (registers 72a and 72b) is a 4 KB boundary, and therefore the next I/O is adjusted by rounding up an I/O address space to the 4 KB boundary (step S414). Thus, although the next I/O is 0x10000 or more, in this case (YES route in step S415), a first empty address after 0x1000 is set to the next I/O (step S416). That is, the address 0x1000 has already been allocated to the other PCI device 81, and therefore the creator 12A avoids the allocation I/O address space and sets the subsequent empty address as the next I/O. In addition, when the next I/O is less than 0x10000 (NO route in step S415), the creator 12A finishes the I/O setting process with respect to the specified bridge without performing the process in step S416.

The process of setting I/O addresses to the devices 81 in the I/O setting subroutine is performed at three stages. First, when I/O addresses to be used are already allocated to another bridge 71 (YES route in step S406), a process (step S407) of cancelling allocation of the I/O addresses to the another bridge 71 is performed. Then, the I/O address range is set to the devices 81 (step S408), and the devices 81 are finally registered in the correspondence table 21 (step S410).

First, the creator 12A retrieves a row in which an address indicated by the next I/O is included in the bridge address field of the correspondence table 21, and “yes” is included in the address allocation field. When there is such a row (YES route in step S406), the address of the next I/O is allocated to the bridge 71 specified based on an identification name of the PCI bridge field of the row. In this case, the creator 12A initializes the allocation of the I/O address space to the bridge 71, and cancels the allocation. The allocation is cancelled by setting 0 to the registers 72a and 72b of the configuration register 72 in the bridge 71. Further, the creator 12A rewrites the address allocation field of the retrieval result row from “yes” to “no”, and registers that the address allocation has been cancelled in the correspondence table 21 (step S407).

Then, the creator 12A sets the next I/O to the I/O address space of the PCI device 81 (step S408). Each device 81 has a length of an I/O address space unique to the device, and then obtains the length from the PCI device and advances the next I/O by the length. Further, the creator 12A adds the I/O address space allocated to the PCI device 81, to the I/O range (step S409).

Finally, the creator 12A adds the row corresponding to the processed device 81, to the correspondence table 21 (step S410). The row to be added adopts the following mode.

PCI device address=I/O address range set to PCI device

PCI bridge=bus number and device number of specified bridge

Bridge address=empty

Address allocation=empty

The bridge address field and the address allocation field are not set at this stage, and are collectively set at a stage at which processing all devices is finished and the I/O address range of the specified bridge is determined.

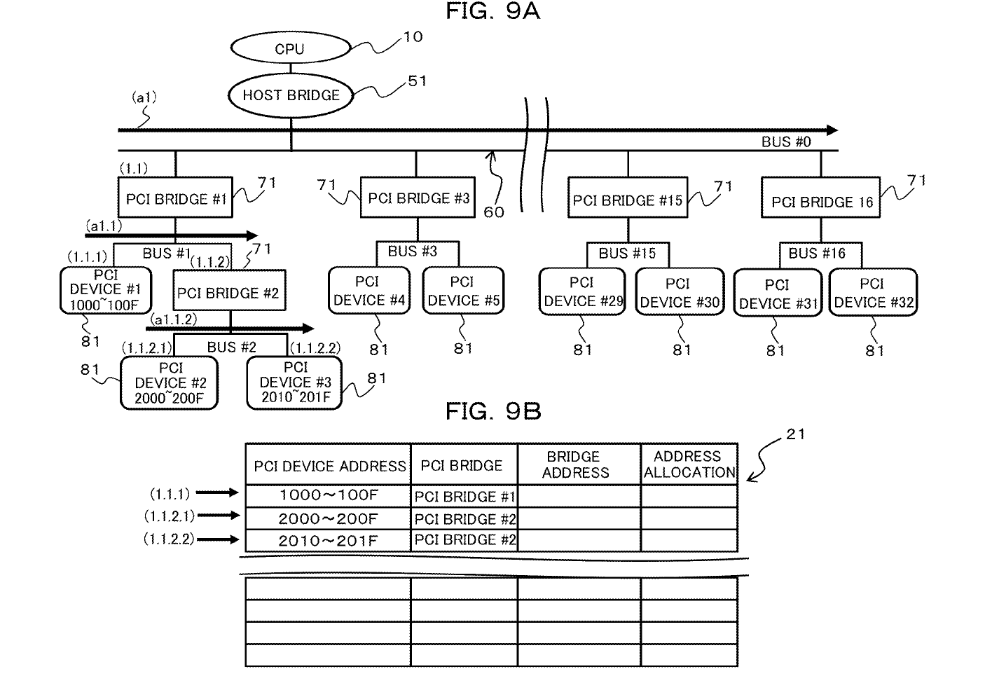

In this regard, the process of setting I/Os to the bridges #1, #2 and #16 and the devices #1 to #3, #31 and #32 of the configuration illustrated in FIG. 8A will be more specifically described with reference to FIGS. 9A to 14B. In addition, FIGS. 9A to 14A illustrate block diagrams that explain the process of setting I/Os to the configuration illustrated in FIG. 8A. Further, FIGS. 9B to 14B illustrate views that illustrate a state where the correspondence table 21 is created for the configurations illustrated in FIGS. 9A to 14A.

First, as illustrated in FIG. 9A, the creator 12A performs a bus scan (a1) on the bus #0, and performs a bus scan (a1.1) on the bus #1 under the bridge #1 when checking the bridge #1 (see (1.1)). The creator 12A allocates an I/O range 1000 to 100F to the device #1 when checking the device #1 (see (1.1.1)) following the bus scan (a1.1) of the bus #1). Further, as illustrated in FIG. 9B, the creator 12A sets “1000 to 100F” to the PCI device address field of a row (1.1.1) of the device #1 in the correspondence table 21, and sets “the PCI bridge #1” to the PCI bridge field of the same row (1.1.1).

The creator 12A performs a bus scan (a1.1.2) on the bus #2 under the bridge #2 when checking the bridge #2 (see (1.1.2)) following the bus scan (a1.1) of the bus #1). The creator 12A allocates an I/O range 2000 to 200F to the device #2 when checking the device #2 (see (1.1.2.1)) following the bus scan (a1.1.2) of the bus #2. Further, as illustrated in FIG. 9B, the creator 12A sets “2000 to 200F” to the PCI device address field of the row (1.1.2.1) of the device #2 in the correspondence table 21, and sets the “PCI bridge #2” to the PCI bridge field of the same row.

The creator 12A allocates an I/O range 2010 to 201F to the device #3 when checking the device #3 (see (1.1.2.2)) following the bus scan (a1.1.2) of the bus #2. Further, as illustrated in FIG. 9B, the creator 12A sets “2010 to 201F” to the PCI device address field of a row (1.1.2.2) of the device #3 in the correspondence table 21, and sets the “PCI bridge #2” to the PCI bridge field of the same row (1.1.2.2).

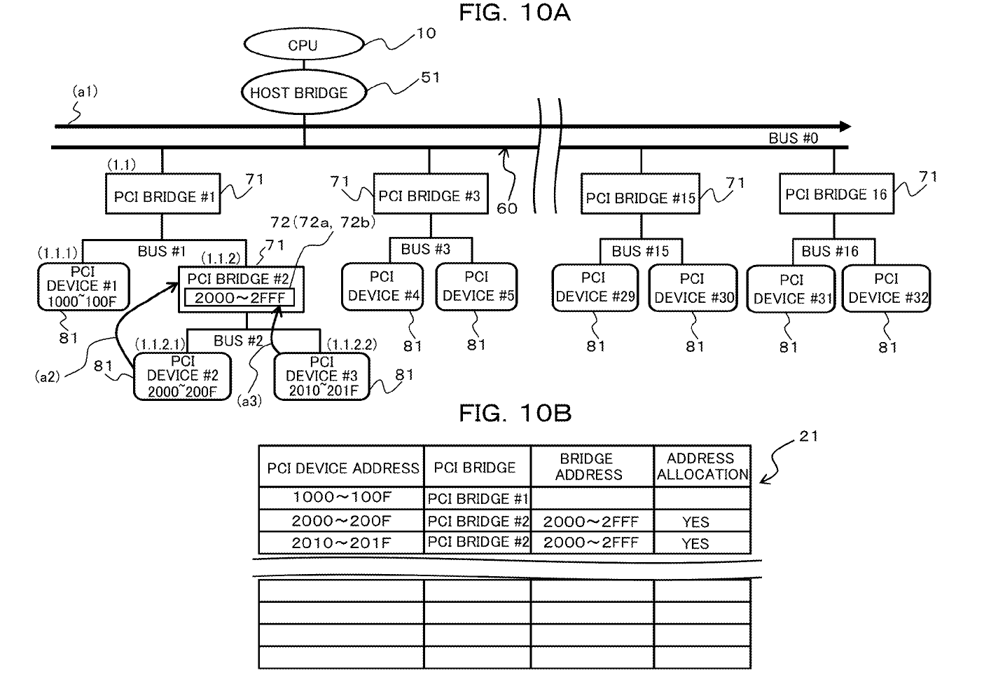

Subsequently, as illustrated in FIG. 10A, the creator 12A allocates the I/O range 2000 to 2FFF of 4 KB including a total sum of the I/O ranges allocated to the devices #2 and #3 under the bridge #2, to the bridge #2 (registers 72a and 72b) (see arrows (a2) and (a3) in FIG. 10A). Further, as illustrated in FIG. 10B, the creator 12A sets “2000 to 2FFF” to the bridge address fields of the rows of the devices #2 and #3 in the correspondence table 21, and sets “yes” to the address allocation fields of the same rows.

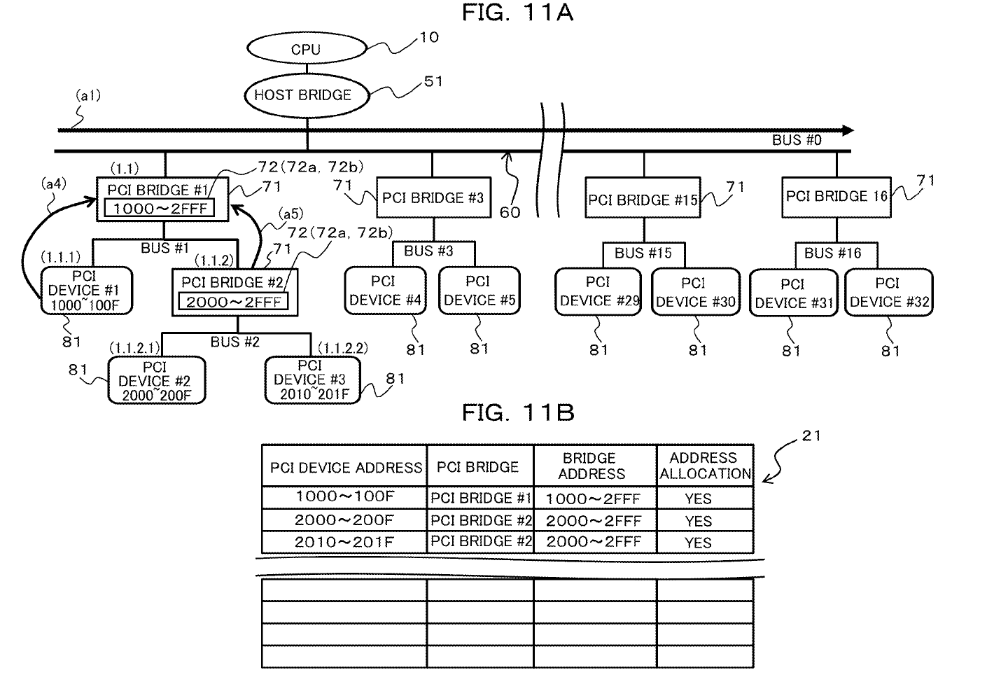

Then, as illustrated in FIG. 11A, the creator 12A allocates the I/O range 1000 to 2FFF of 8 KB including the total sum of the I/O ranges allocated to the device #1 and the bridge #2 under the bridge #1, to the bridge #1 (registers 72a and 72b) (see arrows (a4) and (a5) in FIG. 11A). Further, as illustrated in FIG. 11B, the creator 12A sets “1000 to 2FFF” to the bridge address field of the row of the device #1 in the correspondence table 21, and sets “yes” to the address allocation field of the same row.

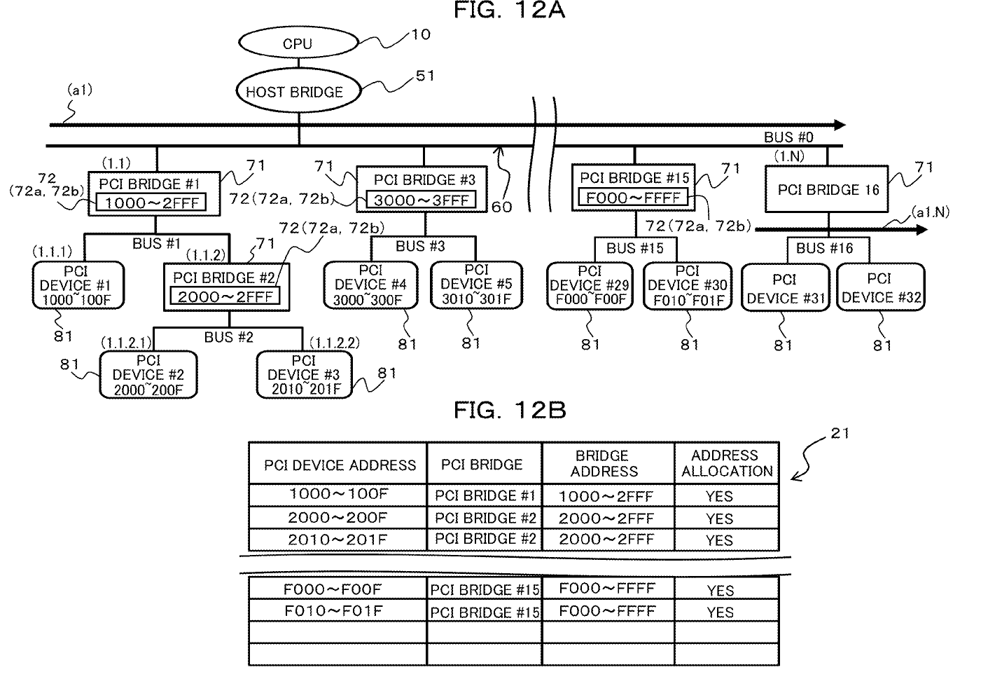

The creator 12A repeats the above I/O setting process, finishes allocating the I/O range to the bridge #15 as illustrated in, for example, FIGS. 12A and 12B and executes the following I/O setting process when unallocated bridge addresses which need to be allocated to the bridge #16 run out. That is, as illustrated in FIG. 12A, the creator 12A performs a bus scan (a1.N) on the bus #16 under the bridge #16 when checking the bridge #16 (see (1.N)) following the bus scan (a1) of the bus #0.

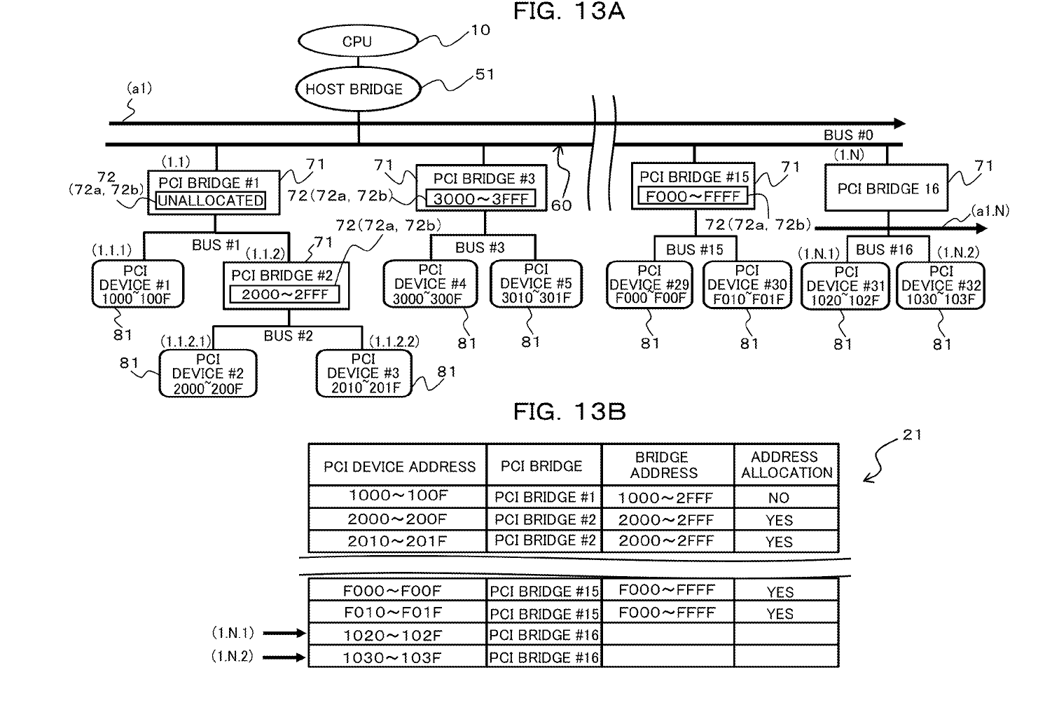

As illustrated in FIG. 13A, the creator 12A allocates an I/O range 1020 to 102F to the device #31 when checking the device #31 (see (1.N.1)) following the bus scan (a1.N) of the bus #16. Further, as illustrated in FIG. 13B, the creator 12A retrieves the bridge address field of the correspondence table 21, and rewrites the address allocation field of the row (the uppermost row in FIG. 13B) including the I/O range 1020 to 102F allocated to the device #31 from “yes” to “no”.

Furthermore, the creator 12A sets “1020 to 102F” to the PCI device address field in the row (1.N.1) of the device #16 in the correspondence table 21, and sets “PCI bridge #16” to the PCI bridge field of the same row. Still further, the creator 12A allocates an I/O range 1030 to 103F to the device #32 when checking the device #32 (see (1.N.2)) following the bus scan (a1.N) of the bus #16. Moreover, as illustrated in FIG. 13B, the creator 12A sets “1030 to 103F” to the PCI device address field of the row (1.N.2) of the device #32 in the correspondence table 21, and sets the “PCI bridge #16” to the PCI bridge field of the same row (1.N.2).

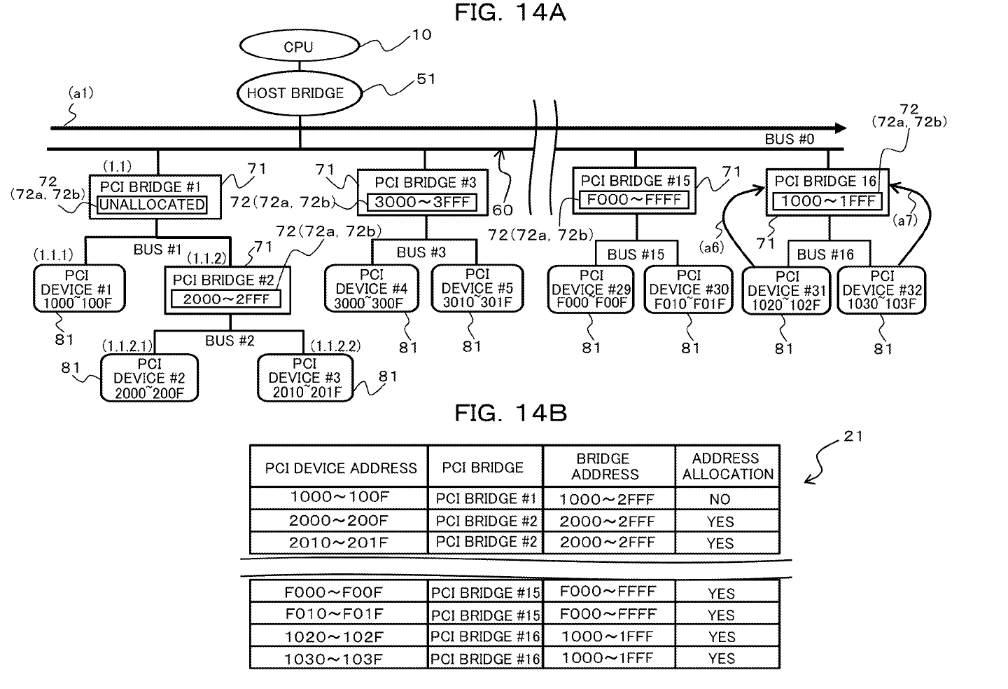

Subsequently, as illustrated in FIG. 14A, the creator 12A allocates the I/O range 1000 to 1FFF of 4 KB including a total sum of the I/O ranges allocated to the devices #31 and #32 under the bridge #16, to the bridge #16 (registers 72a and 72b) (see arrows (a6) and (a7) in FIG. 14A). Further, as illustrated in FIG. 14B, the creator 12A sets “1000 to 1FFF” to the bridge address fields of the rows of the devices #31 and #32 in the correspondence table 21, and sets “yes” to the addresses allocation fields of the same rows.

[1-4] I/O Access Process (Address Allocation Process)

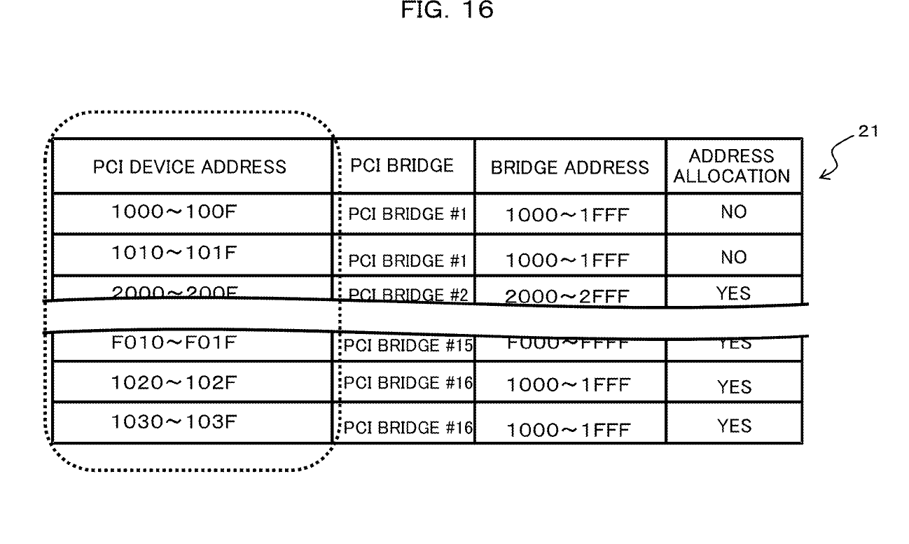

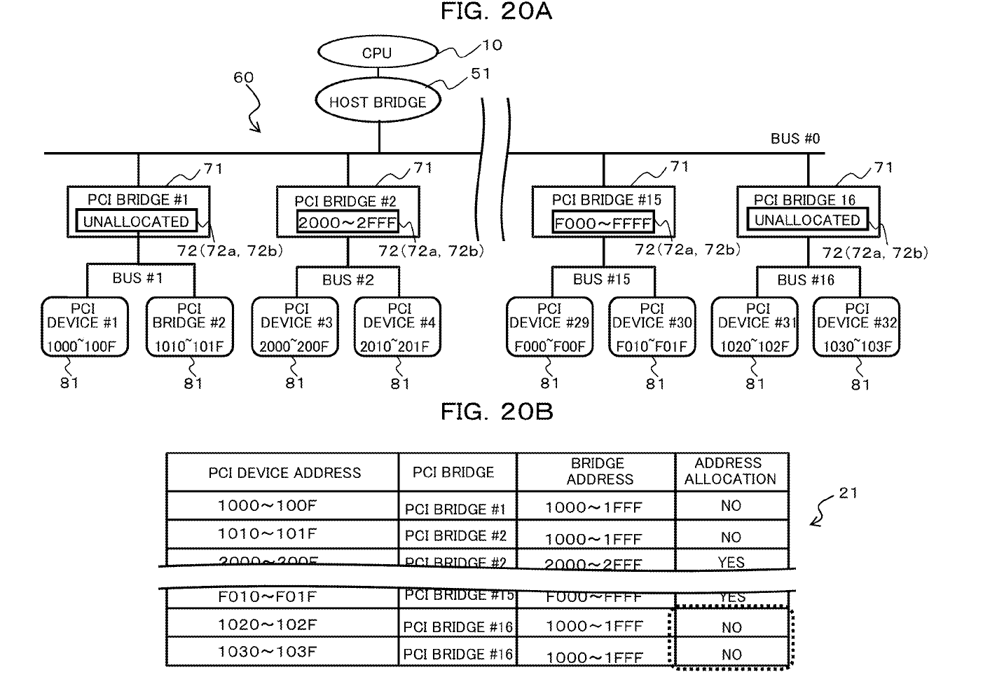

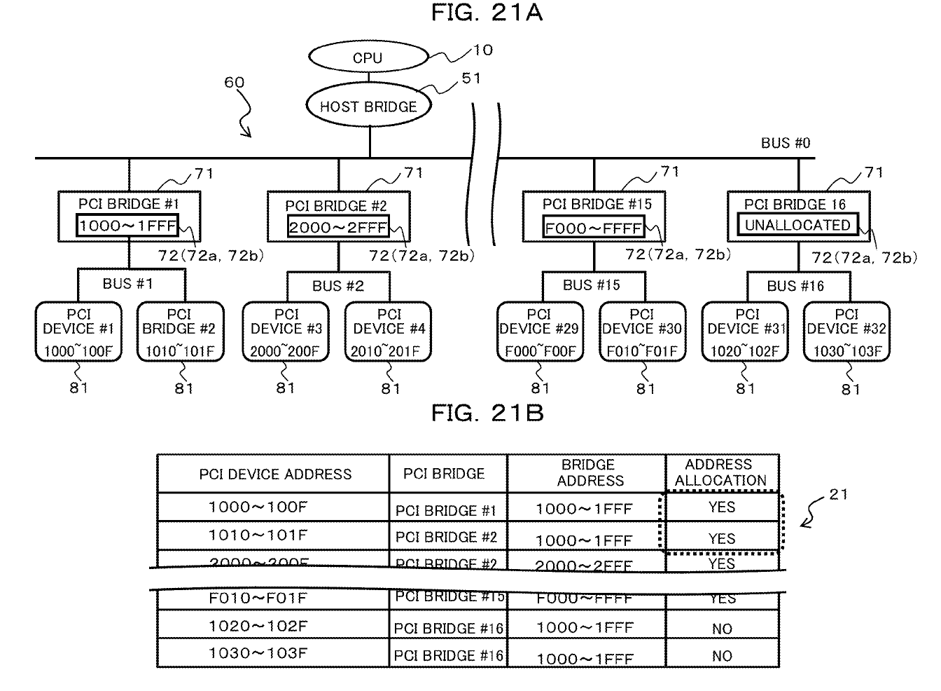

Then, a PCI device I/O access process in the address allocation processor 12B (a process in case where an I/O access to the PCI device 81 is made) will be described in detail according to the flowchart (steps S51 to S57) illustrated in FIG. 15 and with reference to FIGS. 16 to 21B. In this regard, FIGS. 16 to 19 illustrate views that illustrate specific correspondence tables to explain the I/O access process illustrated in FIG. 15. Further, FIGS. 20A and 21A illustrate block diagrams that explain the I/O access process illustrated in FIG. 15, and FIGS. 20B and 21B illustrate views that illustrate states of the correspondence table corresponding to the processes illustrated in FIGS. 20A and 21A. In addition, FIGS. 16 to 21B illustrate the I/O access processes with respect to a configuration which is the same as those in FIGS. 3 and 4, i.e., which includes only one layer of the bridges 71.

There are two types of the I/O access process of the allocator 12B. One process is a process (step S57) in case where I/O address spaces have already been allocated to the bridges 71 (YES route in step S52). The other process is a process (steps S53 to S57) in case where I/O address spaces are not allocated to the bridges 71 (NO route in step S52). In the I/O access process, the allocator 12B determines which one of the above two types of the process is executed first, and executes the process in case where the I/O address spaces have been allocated or executes the process in case where the I/O address spaces are not allocated, according to the determination result. Each process is executed by referring to and updating the correspondence table 21 created by the creator 12A. The I/O access process of the allocator 12B in case where the CPU 10 makes an I/O access to, for example, an address 1000 will be more specifically described.

[1-4-1] Determination of I/O Access Process (Steps S51 and S52)

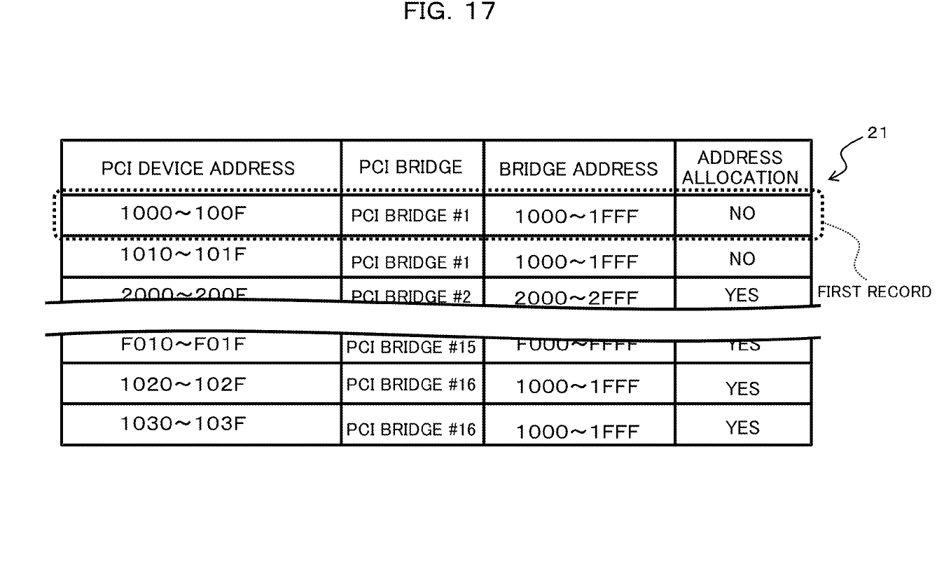

When an I/O access to the PCI device 81 is made, the allocator 12B refers to the correspondence table 21, and determines whether or not an I/O address space is allocated to the bridge 71 connected with the PCI device 81 (step S51). In this case, the allocator 12B checks a column of PCI device addresses of the correspondence table 21 using an I/O access request address as a key. When the I/O range registered in the PCI device address field includes a request address (the address 1000 in this case), the made I/O access is determined as an I/O access to the device 81 in this row (first record) (see FIGS. 16 and 17). That is, the first record (the uppermost row in FIG. 17 in this case) including the request address in the PCI device address field is retrieved from the correspondence table 21. In this regard, upon creation of the correspondence table 21, different I/O address spaces are allocated to all PCI devices 81, and therefore the number of rows found by the retrieval is one at maximum (see FIG. 17). The allocator 12B checks the address allocation field in the retrieved row, and determines that the I/O address has been determined to the bridge 71 when the address allocation field is “yes” (YES route in step S52). Meanwhile, the allocator 12B determines that the I/O is not allocated to the bridge 71 when the address allocation field indicates “no” (when allocation information of the first record is “invalid”) (NO route in step S52).

[1-4-2] Process in Case where I/O Address Space has been Allocated to Bridge

When it is determined that an I/O address space has been allocated to the bridge 71 (YES route in step S52), the I/O address space is adequately allocated to the bridge 71 connected with the PCI device 81. Hence, special processing for the bridge 71 is not necessary, and an I/O access to the PCI devices 81 is executed by making a normal I/O access (step S57).

[1-4-3] Process in Case where I/O Address Space is Not Allocated to Bridge

When it is determined that an I/O address space has not been allocated to the bridge 71 (NO route in step S52), an I/O address space is not allocated to the bridge 71 connected with the PCI devices 81, and the I/O address space is allocated to another bridge 71. The bridge 71 connected with the PCI devices 81 of interest does not decode the I/O access, and therefore even when the I/O access is executed as is, the I/O access is not transferred to the PCI devices 81. Hence, it is necessary to provide a state where the I/O access is transferred to the PCI devices 81 of interest by canceling allocation of the bridge 71 to which the I/O address space is allocated, and reallocating the I/O address space to the bridge 71 connected with the PCI device 81 of interest. More specifically, the allocator 12B performs processes (p1) to (p5) of the following five stages.

(p1) Obtaining of Allocation I/O Address Space

The allocator 12B refers to the correspondence table 21, and obtains I/O address spaces (1000 to 1FFF in this case) of the bridge 71 connected with the access target PCI device 81.

(p2) Obtaining of Cancellation Target Bridge

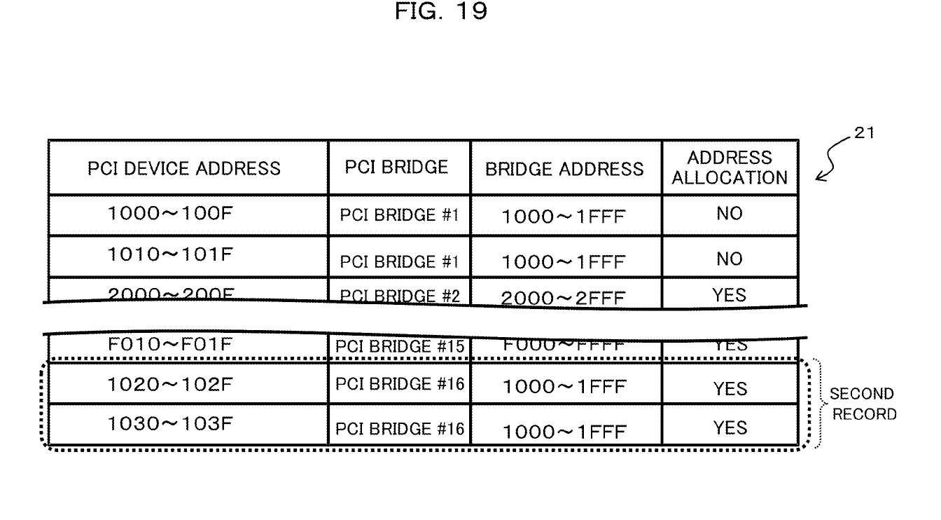

The allocator 12B retrieves the allocation I/O address spaces obtained by the process (p1) from the correspondence table 21, and specifies the bridge 71 (the bridge #16 in this case) to which the allocated I/O addresses are currently allocated as a cancellation target bridge. That is, the allocator 12B retrieves from the correspondence table 21 a second record (see FIG. 19) which includes the same bridge addresses as the bridge addresses of the first record (see FIG. 17), and in which “yes (valid)” is set to the address allocation field.

(p3) Cancellation of Allocation of I/O Address to Cancellation Target Bridge

The allocator 12B cancels allocation of the I/O address space to the bridge 71 specified by the process (p2). That is, the allocator 12B cancels the allocation of the same bridge addresses (1000 to 1FFF) to the second bridge (#16) associated with second bridge identification information (bridge #16) of the second record different from first bridge identification information (bridge #1) of the first record (see FIG. 20A). Further, the allocator 12B sets “no (invalid)” to the address allocation field of the second record (see FIG. 20B).

(p4) Allocation of I/O Address to Setting Target Bridge

The allocator 12B allocates the I/O address space to the bridge 71 connected with the access target PCI device 81. That is, the allocator 12B allocates the same bridge addresses (1000 to 1FFF) to the first bridge (#1) associated with the first bridge identification information of the first record (see FIG. 21A). Further, the allocator 12B sets “yes (valid)” to the address allocation field of the first record (see FIG. 21B).

(p5) I/O Access to PCI Device

[1-4-3-1] Obtaining of Allocation I/O Address Space (Process (p1); Step S53)

The allocator 12B checks contents of the PCI bridge field and the bridge address field of the row (first record) of the correspondence table 21 retrieved and obtained in step S51. By this means, the allocator 12B obtains an ID (#1 in this case) of a setting target bridge to which an I/O address space needs to be allocated, and the I/O address space which needs to be allocated to the setting target bridge. In the example illustrated in FIG. 17, the bridge #1 is obtained as the setting target bridge, and 1000 to 1FFF are obtained as the allocation I/O address space.

[1-4-3-2] Obtaining of Cancellation Target Bridge (Process (p2); Step S54)

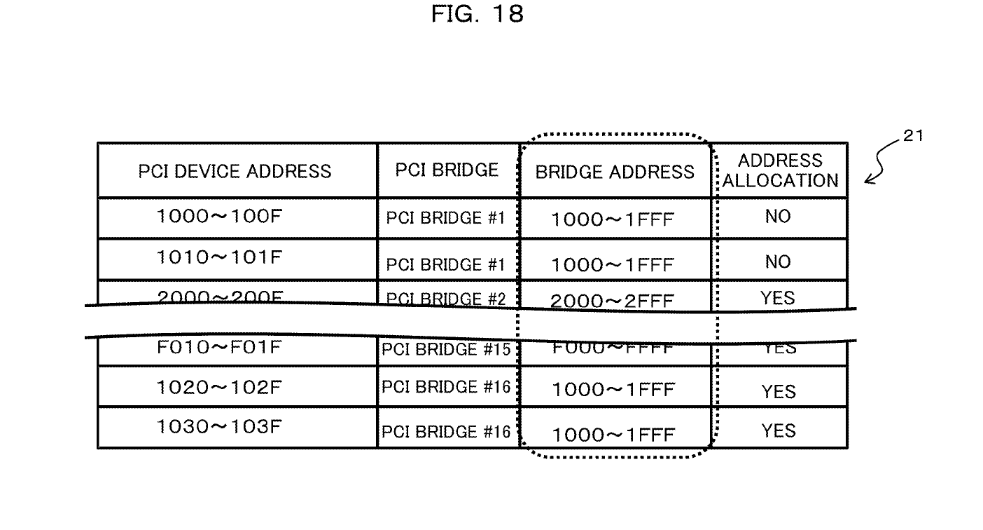

As illustrated in FIG. 18, the allocator 12B sequentially checks the bridge address field of the correspondence table 21 using the allocation I/O address spaces as a key obtained in step S53. By this means, as illustrated in FIG. 19, the allocator 12B retrieves the row (second record) whose bridge addresses set to the bridge address field overlap the allocation I/O address spaces and in which “yes” is set to the address allocation field. The bridge found by this retrieval process is a cancellation target bridge for which allocation of I/O address spaces needs to be cancelled.

In the examples illustrated in FIGS. 18 and 19, the retrieval is performed in the correspondence table 21 using the allocation I/O address space 1000 to 1FFF as a key, and the bridge #16 which overlaps the bridge addresses 1000 to 1FFF of the bridge #1 is obtained as a cancellation target bridge. In the examples illustrated in FIGS. 18 and 19, one bridge is obtained as a bridge which overlaps the bridge addresses 1000 to 1FFF of the bridge #1. However, two or more bridges are obtained in some cases.

[1-4-3-3] Cancellation of Allocation of I/O Address Space to Cancellation Target Bridge (Process (p3); Step S55)

The allocator 12B cancels allocation of an I/O address space to the cancellation target bridge as illustrated in FIG. 20A by setting 0 to both of the registers 72a and 72b of the I/O base address and the I/O limit address of the cancellation target bridge obtained in step S54.

Then, as illustrated in FIG. 20B, the allocator 12B updates to “no” the address allocation field of the row (second record) whose contents of the PCI bridge field of the correspondence table 21 matches with an identification name of the cancellation target bridge. When there is a plurality of rows whose contents of the PCI bridge fields match with an identification name of a cancellation target bridge, the allocator 12B updates to “no” the address allocation fields of all of a plurality of rows.

In the examples illustrated in FIGS. 20A and 20B, the allocator 12B sets 0 to the registers 72a and 72b of the bridge #16 which is the cancellation target bridge, and cancels allocation of the I/O addresses. Subsequently, the allocator 12B updates to “no” the address allocation fields of all rows corresponding to the bridge #16 in the correspondence table 21.

[1-4-3-4] Allocation of I/O Address to Setting Target Bridge (Process (p4); Step S56)

According to the process described so far, the I/O address space which needs to be allocated to the setting target bridge connected with the access target PCI device 81 is released, and is not set to any bridges 71 as illustrated in FIGS. 20A and 20B. In such a state, as illustrated in FIG. 21A, the allocator 12b sets the I/O range to both of the registers 72a and 72b of the I/O base address and the I/O limit address of the setting target bridge, and allocates the I/O address spaces to the setting target bridge. After setting the I/O range to the registers 72a and 72b, the allocator 12B updates to “yes” the address allocation field of the row whose contents of the PCI bridge field of the correspondence table 21 matches with an identification name of the setting target bridge as illustrated in FIG. 21B. When there is a plurality of rows whose contents of the PCI bridge fields match with the identification name of the setting target bridge, the allocator 12B updates to “yes” the address allocation fields of all of a plurality of rows.

In the example illustrated in FIG. 21A, the allocator 12B sets the lower limit value 1000 and the upper limit value 1FFF of the I/O address space respectively to the registers 72a and 72b of the bridge #1 which is the setting target bridge. Further, in the example illustrated in FIG. 21B, the allocator 12B updates to “yes” the address allocation fields of all rows corresponding to the bridge #1 in the correspondence table 21. As a result, a necessary I/O address space is set to the bridge 71 connected with the I/O access target device 81, and the bridge 71 decodes the I/O address and starts transferring an I/O access to the access target PCI device 81.

[1-4-3-5] I/O Access to PCI Device (Process (p5); Step S57)

A requested I/O access is executed. The I/O access is transferred to the access target PCI device 81 through the bridge 71 set in step S56, and the I/O access with respect to the PCI device 81 is executed. By this means, the OS or an application operating in the CPU 10 obtains a desired result.

[1-5] Effect of First Embodiment

In the above computer system 1 according to the first embodiment, the allocator 12B executes the I/O access process with respect to the device 81 when the creator 12A cancelling allocation of I/O address spaces to the bridges 71 and reallocating the I/O address spaces to the bridges 71 while referring to and updating the correspondence table 21 created upon initialization of the PCI buses. Consequently, even when the (e.g. 16 or more) bridges 71 the number of which exceeds a predetermined number are provided in the computer system 1 and therefore bridge addresses run out, it is possible to simultaneously use the bridges 71 the number of which exceeds the predetermined number.

[2] Information Processing Device According to Second Embodiment

[2-1] Configuration According to Second Embodiment

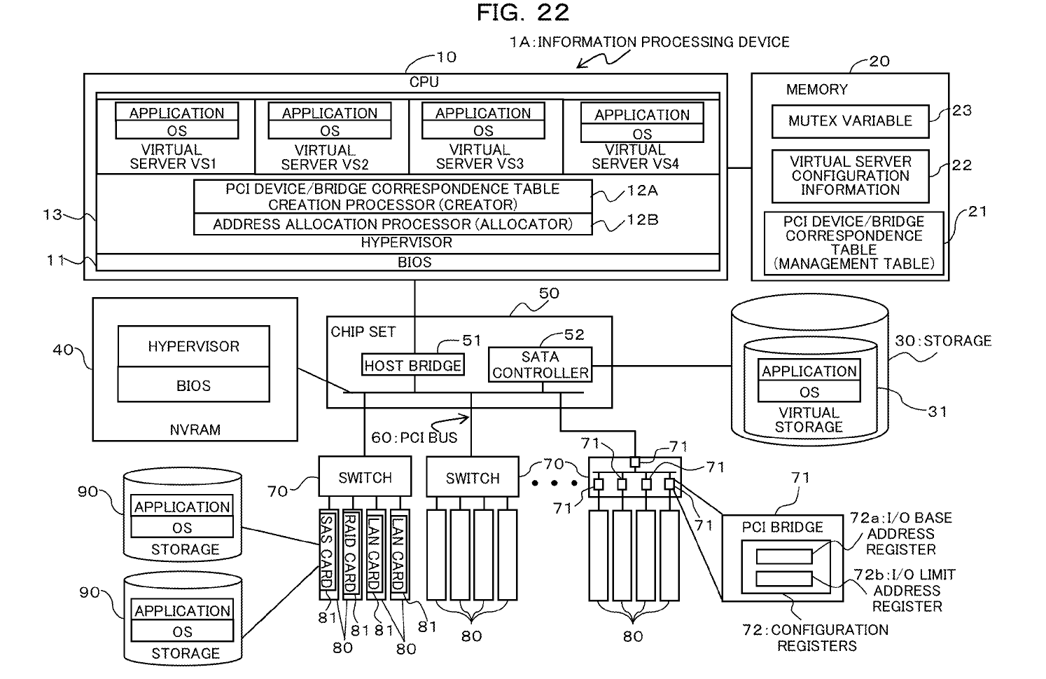

FIG. 22 illustrates a block diagram that illustrates a configuration of an information processing device (computer system) 1A according to the second embodiment. In addition, the same reference numerals as the above-described reference numerals indicate the same or substantially same components, and therefore will not be described.

The computer system 1A illustrated in FIG. 22 also has a CPU 10, a memory 20, a storage 30, a NVRAM 40, a chip set 50, PCI buses 60, switches 70, slots 80 and storages 90 similar to the computer system 1 according to the first embodiment.

Meanwhile, the computer system 1A illustrated in FIG. 22 includes a general architecture which constructs a plurality of (4 in FIG. 22) virtual servers VS1 to VS4. Further, a BIOS program includes a built-in hypervisor program which causes the CPU 10 to function as a hypervisor 13. The hypervisor program includes a control program which causes the CPU 10 to function as a PCI device/bridge correspondence table creation processor 12A and an address allocation processor 12B described above. In addition, when the hypervisor 13 virtualizes a calculator, a speed of a process is increased using VT-d and VT-x which are various virtualization support functions of Intel.

Further, in the storage 30, a virtual storage 31 including an OS and application programs of the virtual servers VS1 to VS4 is constructed.

In the memory 20, the CPU 10 expands and stores a BIOS program read from the NVRAM 40 and the OS and the application program read from the virtual storage 31 by the virtual servers VS1 to VS4. Further, the memory 20 stores the above correspondence table 21 and, in addition, virtual server configuration information 22 created and updated by the hypervisor 13, and a MUTEX variable 23 described below.

The CPU 10 functions as the above-described PCI device/bridge correspondence table creation processor 12A and address allocation processor 12B by executing the control program included in the hypervisor program read from the NVRAM 40 after activating the computer system 1A.

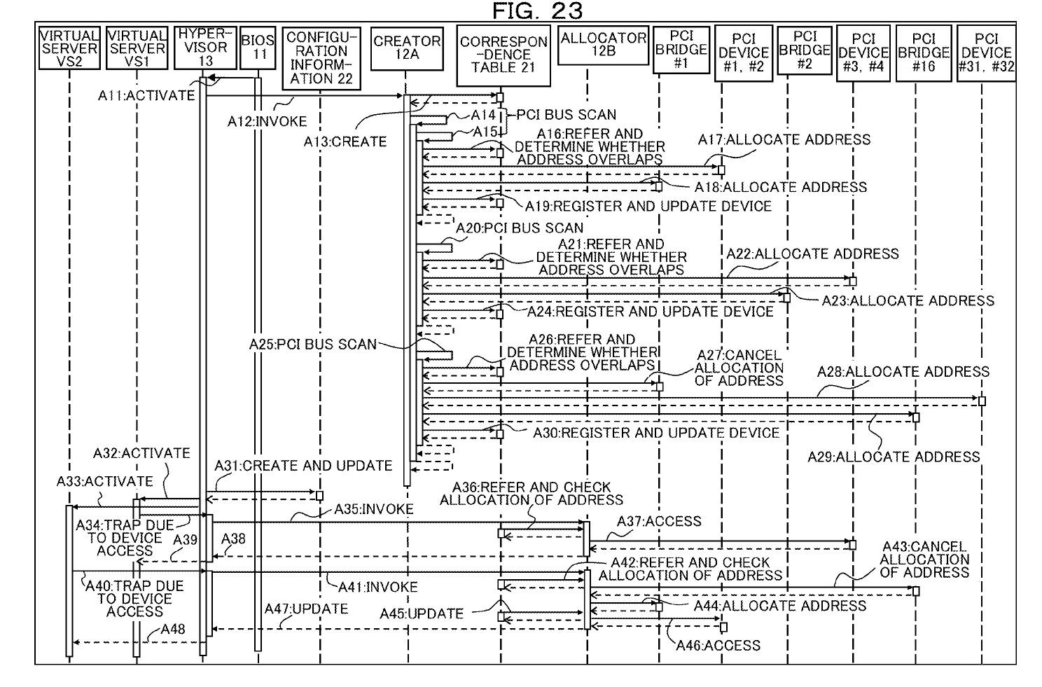

The PCI device/bridge correspondence table creation processor 12A is invoked during the initialization process of the hypervisor 13 upon activation of the computer system 1A, and performs the process of creating the correspondence table 21. The process of creating the correspondence table 21 in the PCI device/bridge correspondence table creator 12A according to the second embodiment will be more specifically described with reference to FIGS. 23 to 27.

Further, when the hypervisor 13 detects (traps) an I/O access with respect to the PCI device 81 from one of the virtual servers VS1 to VS4, the address allocation processor 12B is invoked and performs a process of allocating I/O address spaces. The process of allocating addresses in the address allocation processor 12B according to the second embodiment will be more specifically described with reference to FIGS. 23, 28 and 29.

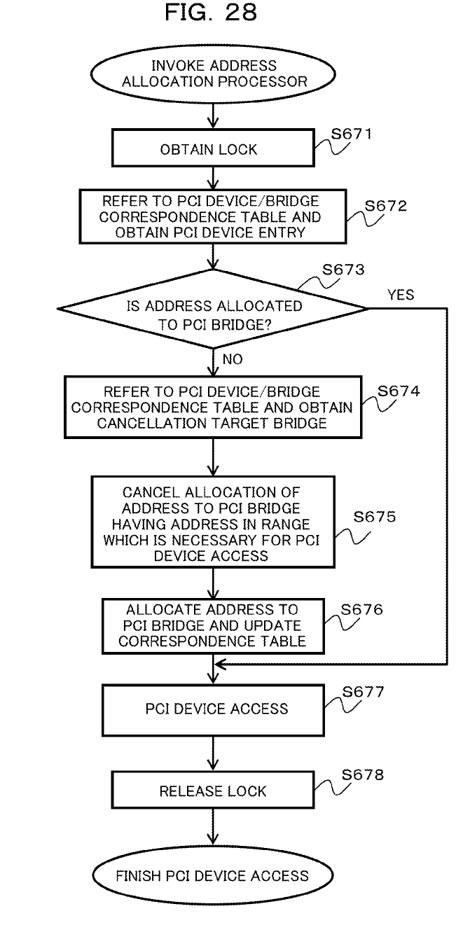

In addition, when the hypervisor 13 detects an I/O access from another virtual server before the address allocation processor 12B finishes executing the same I/O access after being invoked to detect an I/O access, the address allocation processor 12B causes a process with respect to another access to stand by until executing a preceding access is finished. The stand-by process of the address allocation processor 12B is performed using the MUTEX (MUTual EXclustion) variable 23 of the memory 20. When the hypervisor 13 detects an I/O access from still another virtual server and invokes the address allocation processor 12B, the address allocation processor 12B obtains a lock by setting “1” to the MUTEX variable 23. The address allocation processor 12B releases the lock by setting the MUTEX variable 23 to “0” upon finishing the access. Thus, the address allocation processor 12B (hypervisor 13) exclusively uses the correspondence table 21 by causing a subsequent access to stand by while setting the MUTEX variable 23 to “1” upon an I/O access from the virtual servers VS1 to VS4 to the devices 81. The above-described stand-by process of the address allocation processor 12B will be described with reference to FIG. 28.

[2-2] Flow of Process According to Second Embodiment

An operation of the computer system 1A according to the second embodiment will be described below in more detail with reference to FIGS. 23 to 29.

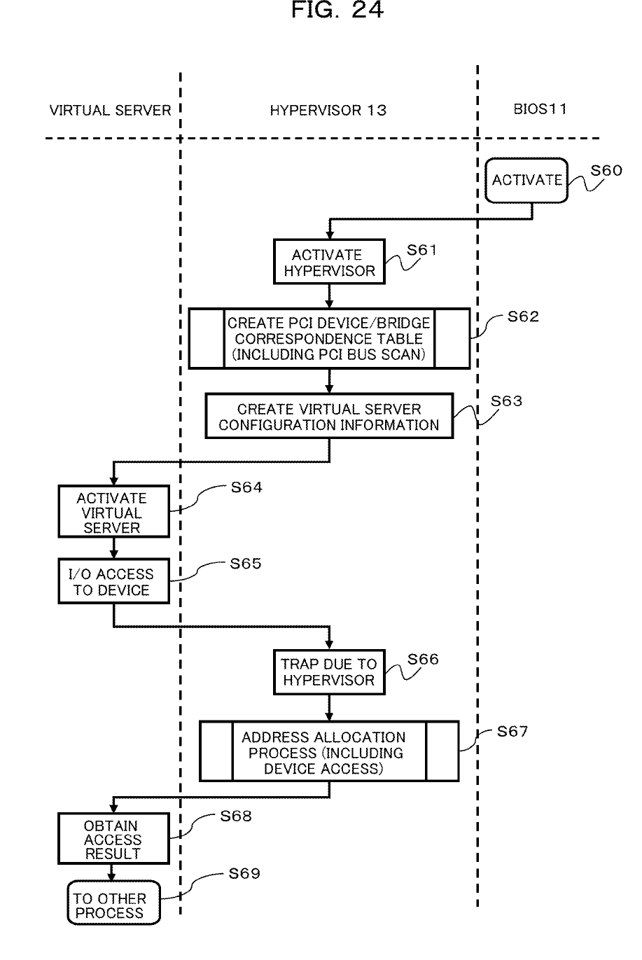

First, a flow of a process of the computer system 1A according to the second embodiment will be described according to a sequence diagram (arrows A11 to A48) illustrated in FIG. 23 and a flowchart (steps S60 to S69) illustrated in FIG. 24.

When the computer system 1A is activated, the CPU 10 activates the BIOS 11 by reading the BIOS program including the built-in hypervisor program from the NVRAM 40, expanding the BIOS program to the memory 20 and executing the BIOS program (see step S60). The BIOS 11 executes a process of initializing the computer system 1A and activates the hypervisor 13 (arrow A11; step S61).

When being activated, the hypervisor 13 invokes a function of the PCI device/bridge correspondence table creation processor (creator) 12A (arrow A12), and creates the PCI device/bridge correspondence table 21 on the memory 20 while performing a PCI bus scan (arrows A13 to A30; step S62). The process of creating the correspondence table 21 in the creator 12A will be described later with reference to the arrows A13 to A30 in FIG. 23 and FIGS. 25 to 27.

The hypervisor 13 creates the correspondence table 21, then constructs the virtual servers VS1 to VS4 and changes configurations of the virtual servers VS1 to VS4, creates the virtual server configuration information 22 and stores the virtual server configuration information 22 in the memory 20 (arrow A31; step S63). The hypervisor 13 allocates devices to the virtual servers VS1 to VS4 based on the virtual server configuration information 22, and then activates the virtual servers VS1 to VS4 (arrows A32 and A33; step S64). The virtual servers VS1 to VS4 read the OS from the storage 30 (virtual storage 31) allocated thereto, expands the OS to the memory 20, activates the OS and causes an application to operate on the OS. In addition, FIG. 23 illustrates the two virtual servers VS1 and VS2.

When issuing an I/O access to the device 81 allocated to each virtual server after the virtual servers VS1 to VS4 are activated (step S65), the hypervisor 13 detects and traps an I/O access request (arrows A34 and A40; step S66). The hypervisor 13 traps the I/O access request, the I/O addresses of the device 81 when seen from the virtual servers VS1 to VS4 are converted into the I/O addresses of the hypervisor 13 based on the virtual server configuration information 22. Subsequently, the hypervisor 13 invokes the function of the address allocation processor (allocator) 12B, executes the address allocation process and executes the I/O access to the device 81 (arrows A35 to A38 and A41 to A47; step S67). Further, the hypervisor 13 returns a process result of an access to the device 81 to the virtual server (arrows A39 and A48), and the virtual server obtains a result of the access to the device 81 (step S68) and transitions to another process (step S69). The address allocation process of the allocator 12B will be described below with reference to the arrows A35 to A38 and A41 to A47 in FIG. 23 and FIGS. 28 and 29.

[2-2-1] Correspondence Creation Process (Step S62)

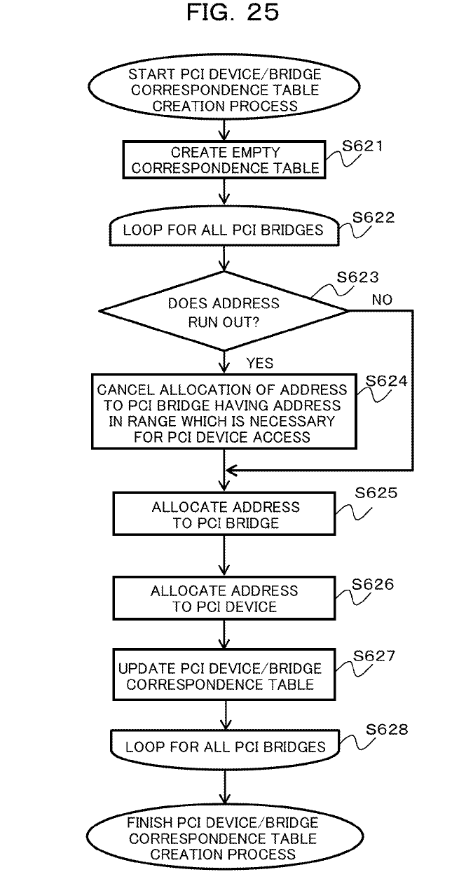

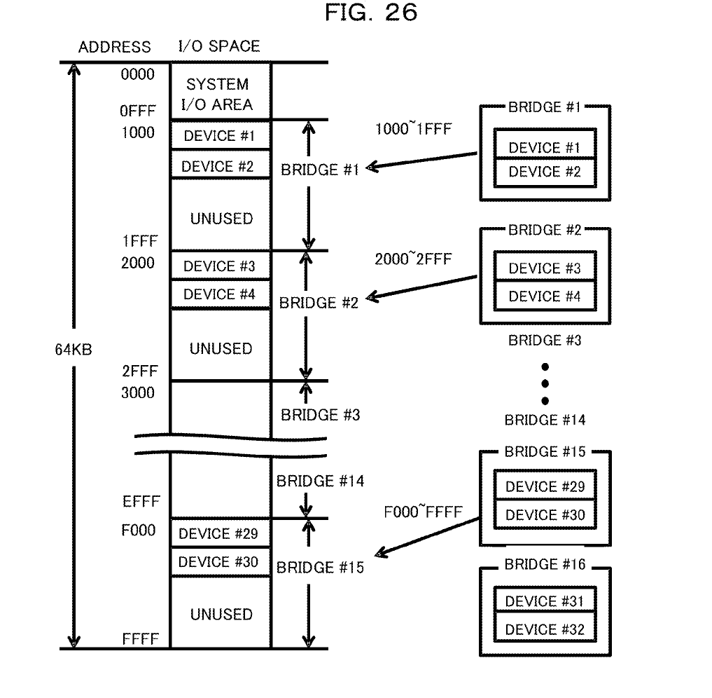

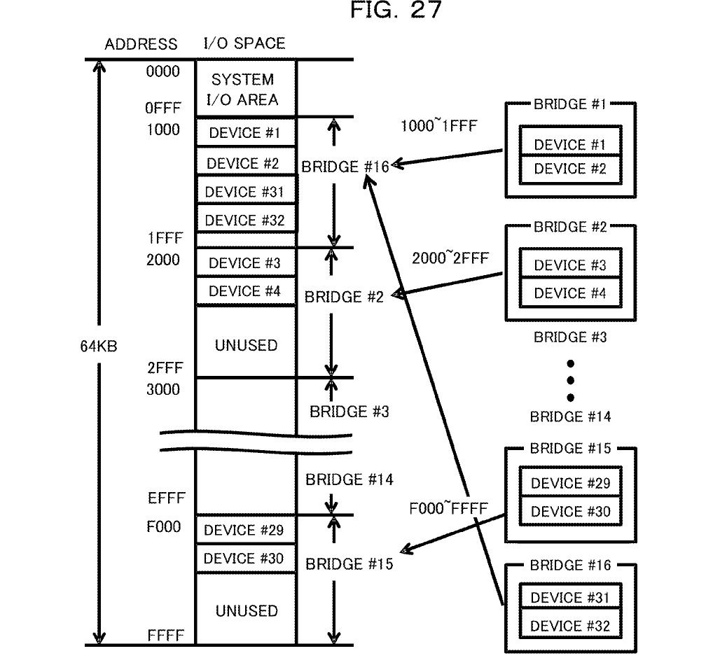

Next, the process of creating the correspondence table 21 in the creator 12A will be described according to the arrows A13 to A30 illustrated in FIG. 23 and the flowchart (steps S621 to S628) illustrated in FIG. 25 and with reference to FIGS. 26 and 27. In addition, FIGS. 26 and 27 illustrate views that explain a process in case where bridge addresses run out in the process of creating the correspondence table 21 illustrated in FIG. 25. In addition, a case where the process of creating the correspondence table 21 and an address allocation process are performed with respect to the same configuration as those in FIGS. 3 and 4, i.e., a configuration including only one layer of the bridges 71 will be described.

The creator 12A creates the empty correspondence table 21 (arrow A13; step S621), and executes the following process (arrows A14 to A30; steps S622 to S628) with respect to all PCI bridges 71 (#1 to #16). That is, the creator 12A registers the bridges 71 through which accesses to each device 81 are made, addresses which are allocated to each device 81 and each bridge 71, and whether address allocation is valid or invalid in the correspondence table 21 following execution of a PCI bus scan (arrows A14, A15, A20 and A25) through allocating I/O addresses to each bridge 71 and each device 81.

In this process, the creator 12A refers to the correspondence table 21, and determines whether or not unallocated I/O addresses which can be allocated to the bridges 71 run out (overlapping determination; arrows A16, A21 and A26; step S623). When unallocated I/O addresses which can be allocated to the bridges 71 do not run out (arrows A16 and A21; NO route in step S623), the creator 12A allocates unallocated addresses to each bridge 71 and each device 81 (arrows A18, A17, A23 and A22; steps S625 and S626). Further, the creator 12A registers the allocation result in the correspondence table 21 and updates the correspondence table 21 in regard to the allocation result (arrows A19 and A24; step S627).

The creator 12A allocates I/O address spaces to bridges #1 to #15 as illustrated in FIG. 26 by repeatedly executing the same process with respect to the bridges #1 to #15. At this point of time, I/O address spaces run out, and the creator 12A cannot allocate a new I/O address space to a 16th bridge #16.

As illustrated in FIG. 26, when unallocated I/O addresses which can be allocated to the bridges 71 run out and new I/O addresses cannot be allocated to the bridges 71 (arrow A26; YES route in step S623), the creator 12A performs the following process. That is, as illustrated in FIG. 27, the creator 12A cancels allocation of addresses to the bridge #1 which has already been registered in the correspondence table 21 (arrow A27; step S624), and allocates addresses 1000 to 1FFF to a new bridge #16 (arrow A29; step S625). In this case, the address allocation of the bridge #1 is canceled by setting 0 to the registers 72a and 72b of the bridge #1 as described above. Further, the creator 12A allocates I/O addresses 1020 to 102F and 1030 to 103F to devices #31 and #32 connected to buses of the newly allocated bridge #16 (arrow A28; step S626). In this case, the creator 12A allocates the I/O addresses 1020 to 102F and 1030 to 103F of the devices #31 and #32 such that the I/O addresses 1000 to 100F and 1010 to 101F of the devices #1 and #2 connected to the bridge #1 whose address allocation has been cancelled. Subsequently, the creator 12A updates the correspondence table 21 according to a result of allocation cancellation and reallocation performed in steps S624 to S626 (arrow A30; step S627).

In addition, in FIG. 23, addresses are allocated to the devices 81 and then addresses are allocated to the bridges 71. Meanwhile, in FIG. 25, addresses are allocated to the bridges 71 and then addresses are allocated to the devices 81. An order to execute an address allocation of the bridges 71 and an address allocation to the devices 81 is not limited.

[2-2-2] Address Allocation Process (Step S67)

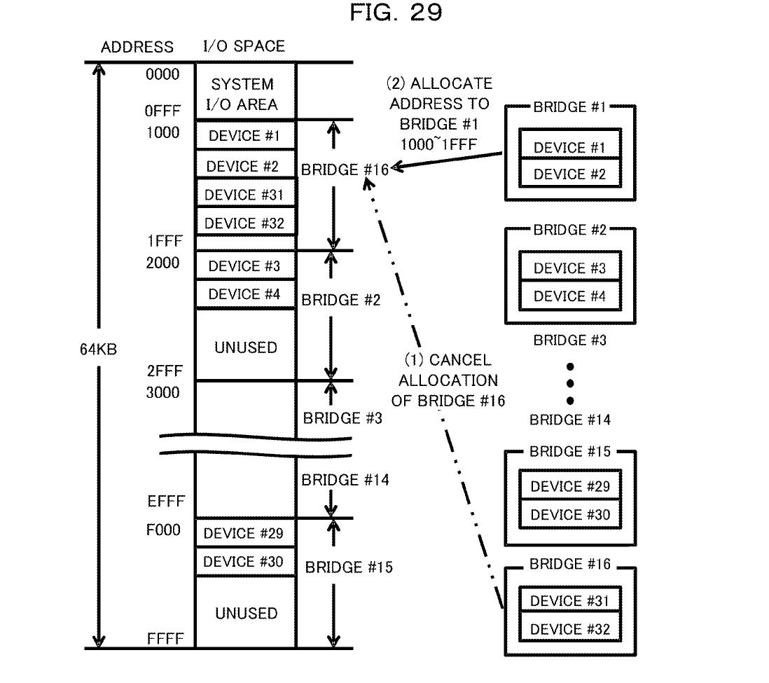

Next, an address allocation process of the allocator 12B will be described according to the arrows A35 to A38 and A41 to A47 illustrated in FIG. 23 and a flowchart illustrated in FIG. 28 (steps S671 to S678) and with reference to FIG. 29. In addition, FIG. 29 illustrates a view that explains a process in case where the access target device 81 belongs to the address unallocated bridge 71 in the address allocation process illustrated in FIG. 28.

When being invoked by the hypervisor 13 and activated (arrows A35 and A41), the allocator 12B obtains a MUTEX and places a lock (step S671), and performs retrieval in and refers to the correspondence table 21 using as I/O addresses of the transfer destination device 81 of the I/O access request trapped by the virtual server VS1 as a key. By this means, the allocator 12B obtains an entry (a row and a record) of the transfer destination device 81 in the correspondence table 21, and checks a setting state of the current I/O addresses (arrows A36 and A42; step S672).

In this regard, in the second embodiment, while a request for an I/O access from one of the virtual servers VS1 to VS4 to the device 81 is processed, a request for an I/O access from another virtual server to another device 81 is likely to be made. In this case, when processes of referring to and updating the correspondence table 21 are simultaneously performed, it is not possible to maintain a match of the correspondence table 21. Therefore, it is necessary to exclusively control the correspondence table 21 upon the address allocation process of the allocator 12B.

Then, the allocator 12B according to the second embodiment exclusively controls the correspondence table 21 using a shared memory area (see the MUTEX variable 23 on the memory 20) which takes a value of “1” or “0” called a MUTEX variable. The allocator 12B accesses the MUTEX variable 23 and performs an exclusive process as follows when trapping an I/O access request from each virtual server to the device 81.

That is, the allocator 12B first checks a value of the MUTEX variable 23 on the memory 20. When the value of the MUTEX variable 23 is “1”, the correspondence table 21 is used for a process corresponding to an access from another virtual server which precedes a current access. Hence, the allocator 12B causes the current access to stand by until the value of the MUTEX variable 23 takes “0”.

Meanwhile, that the value of the MUTEX variable 23 is “0” indicates that no virtual server uses the correspondence table 21. In this case, the allocator 12B sets the value of the MUTEX variable 23 from “0” to “1”, and obtains a lock by switching to a state indicating that the correspondence table 21 is used (places the lock; step S671). In this state, another virtual server waits for a process until the value of the MUTEX variable 23 takes “0” as described above. Hence, a virtual server which has obtained a MUTEX, i.e., a virtual server which has switched the value of the MUTEX variable 23 to “1” can exclusively use the correspondence table 21.

Then, the allocator 12B refers to the entry obtained in step S672, and determines whether or not I/O addresses are allocated the bridge 71 connected to the access target device 81, i.e., whether “yes” is set to the address allocation field of the entry (step S673). When I/O addresses are allocated (YES route in step S673), an I/O address space is adequately allocated to the bridge 71. Hence, a special process for the bridge 71 is not necessary, and an I/O access to the PCI device 81 is executed by making a normal I/O access (arrow A37; step S677). By this means, the virtual server VS1 which has issued an I/O access request obtains a desired result (arrows A38 and A39).

When the I/O access to the PCI device 81 is finished, the allocator 12B releases the lock. That is, the allocator 12B reverses the value of the MUTEX variable 23 from “1” to “0” and releases the lock (step S678). By this means, another virtual server which has been standing by so far can obtain a MUTEX and use the correspondence table 21.

By contrast with this, when it is determined in step S673 that I/O addresses are not allocated (NO route in step S673), the allocator 12B refers to the correspondence table 21 and obtains the bridge 71 (e.g., the bridge #16) to which necessary I/O addresses are set as a cancellation target bridge (arrow A42; step S674). Subsequently, the allocator 12B cancels the I/O addresses 1000 to 1FFF of the cancellation target bridge #16 (arrow A43; step S675; see arrow (1) in FIG. 29). Subsequently, the allocator 12B allocates the I/O addresses 1000 to 1FFF to the bridge 71 (e.g. #1) connected with the access target device 81 (arrow A44; step S676; see arrow (2) in FIG. 29), and updates the correspondence table 21 (arrow A45; step S676).

When the I/O addresses are set to the bridge #1, the hypervisor 13 (allocator 12B) accesses the device #1 or #2 (arrow A46; step S677). By this means, the virtual server VS2 which has issued an I/O access request obtains a desired result (arrows A47 and A48). Subsequently, as described above, the allocator 12B reverses the value of the MUTEX variable 23 from “1” to “0”, and releases the lock (step S678). By this means, another virtual server which has been standing by so far can obtain a MUTEX and use the correspondence table 21.

[2-3] Effect of Second Embodiment

In the above computer system 1A according to the second embodiment, similar to the first embodiment, the allocator 12B executes an I/O access process with respect to the device 81 when the creator 12A cancels allocation of I/O address spaces to the bridges 71 and reallocates the I/O address spaces to the bridges 71 while referring to and updating the correspondence table 21 created upon initialization of the PCI buses. Consequently, even when the (e.g. 16 or more) bridges 71 the number of which exceeds a predetermined number are provided in the computer system 1A and therefore bridge addresses run out, it is possible to simultaneously use the bridges 71 the number of which exceeds the predetermined number.

Further, when I/O access requests from a plurality of virtual servers to the devices 81 allocated to each virtual server are issued, the computer system 1A according to the second embodiment causes the process of the virtual servers which have issued the I/O access requests to stand by until the lock based on a MUTEX is released. That is, even when an I/O access request from another virtual server to another device 81 is made while the I/O access request from one virtual server to the device 81 is processed, a process related to the subsequent I/O stands by until the process related to the preceding I/O access request is finished. Consequently, it is possible to reliably prevent the subsequent I/O access request from causing an unmatch in the correspondence table 21. In, for example, FIG. 23, a process (arrows A34 to A39) related to the I/O access request from the virtual server VS1 is finished, and then the process (arrows A40 to A48) related to the I/O access request from the virtual server VS2 is executed.

[3] Information Processing Device According to Third Embodiment

[3-1] Configuration According to Third Embodiment

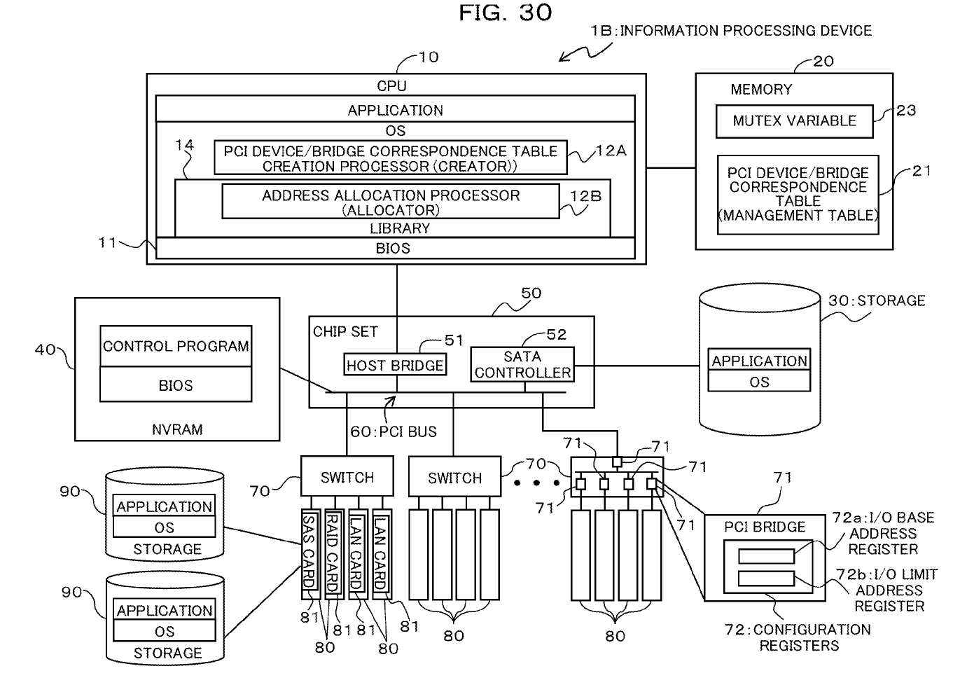

FIG. 30 illustrates a block diagram that illustrates a configuration of an information processing device (computer system) 1B according to the third embodiment. In addition, the same reference numerals as the above-described reference numerals indicate the same or substantially same portions, and therefore will not be described.

Similar to a computer system 1 according to the first embodiment, the computer system 1B illustrated in FIG. 30 also has a CPU 10, a memory 20, a storage 30, a NVRAM 40, a chip set 50, PCI buses 60, switches 70, slots 80 and storages 90.

Meanwhile, the computer system 1B illustrated in FIG. 30 performs the above process of creating a correspondence table 21 in the PCI device/bridge correspondence table creation processor (creator) 12A in a process of activating an OS. Further, a function of an address allocation processor (allocator) 12B described above is included a library 14 of an OS in the CPU 10 which is used to access one device of a plurality of devices 81.

[3-2] Flow of Process According to Third Embodiment

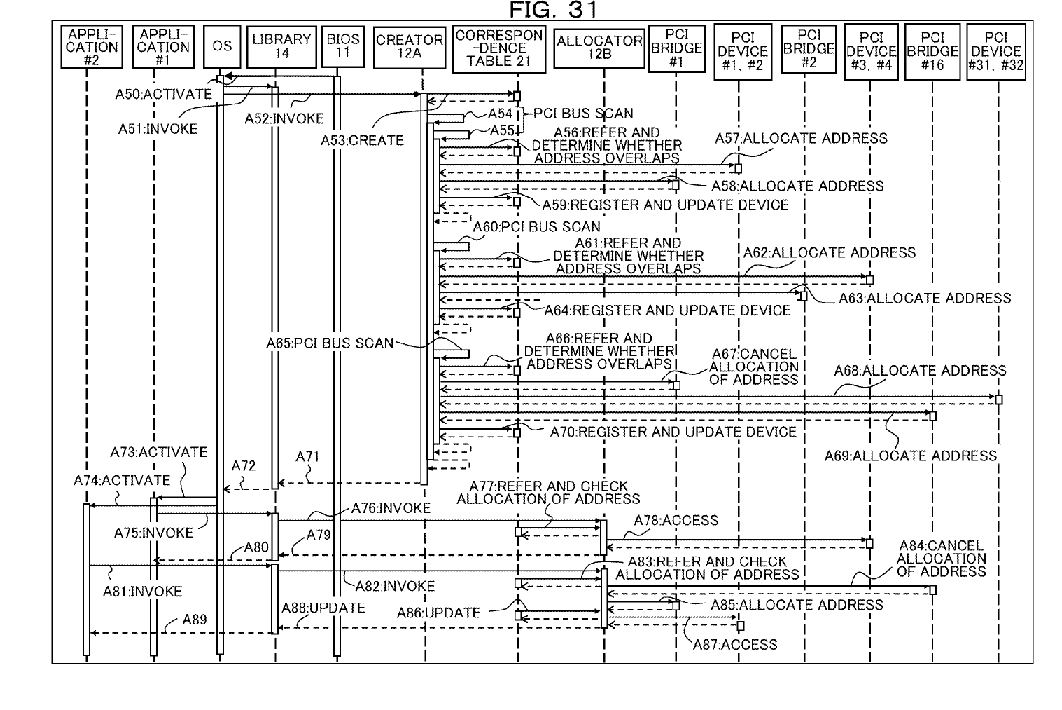

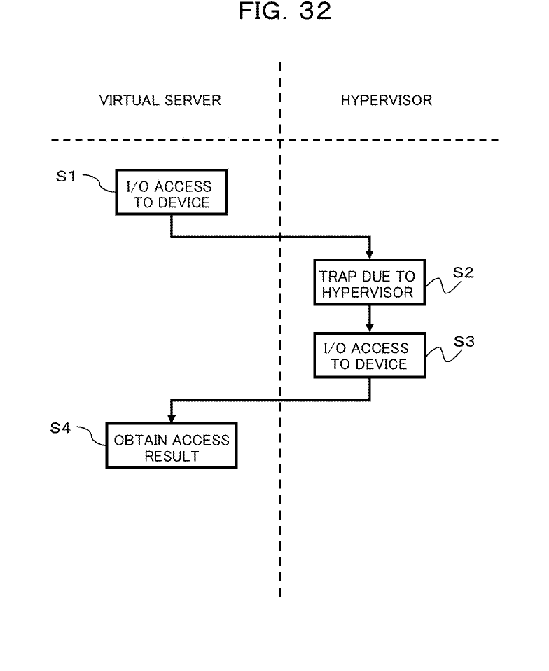

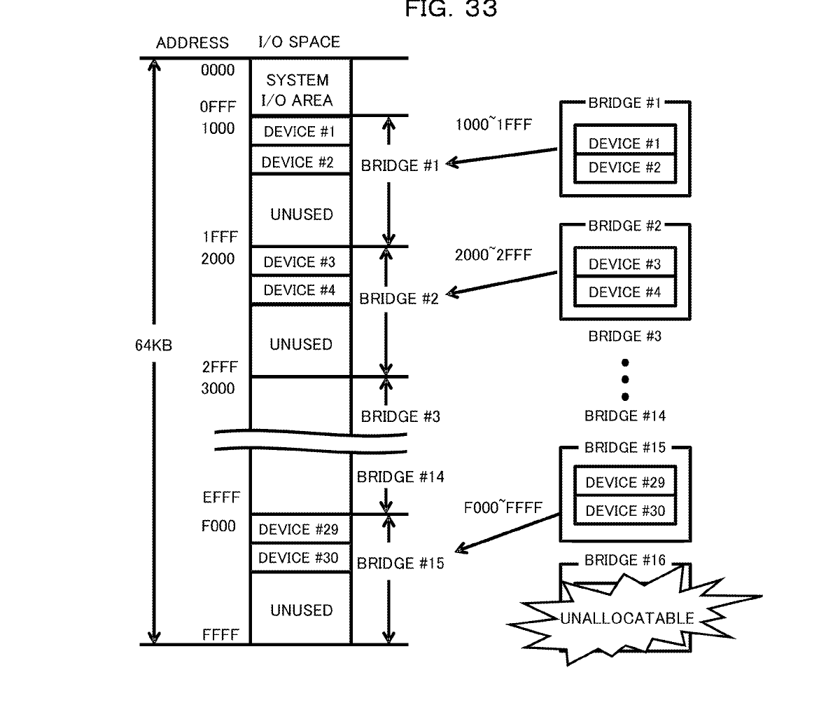

Next, a flow of a process of the computer system 1B according to the third embodiment will be described according to a sequence diagram (arrows A50 to A89) illustrated in FIG. 31.

When the computer system 1B is activated, the CPU 10 activates a BIOS 11 by reading a BIOS program from the NVRAM 40, expanding the BIOS program onto the memory 20, and executing the BIOS program. The BIOS 11 executes a process of initializing the computer system 1B, then reads the OS from the storage 30, expands the OS onto the memory 20 and activates the OS (arrow A50).

The OS invokes the function of the PCI device/bridge correspondence table creation processor (creator) 12A through the library 14 upon activation (arrows A51 and A52). The creator 12A creates the PCI device/bridge correspondence table 21 on the memory 20 while performing a PCI bus can again separately from the BIOS 11 (arrows A53 to A70). The process (arrows A53 to A70) of creating the correspondence table 21 in the creator 12A is the same as the creation process (arrows A13 to A30 in FIG. 23) described in the second embodiment.

In the process of creating the correspondence table 21 in the creator 12A, the above pieces of information (a1) to (a4) are registered in the correspondence table 21 by allocating I/O addresses to each bridge 71 and each device 81. In this process, the creator 12A refers to the correspondence table 21, and determines whether or not unallocated I/O addresses which can be allocated to the bridges 71 run out (overlapping determination; arrows A56, A61 and A66). When the unallocated I/O addresses which can be allocated to the bridges 71 do not run out (arrows A56 and A61), the creator 12A allocates the unallocated addresses to each bridge 71 and each device 81 (arrows A58, A57, A63 and A62). Further, the creator 12A registers the allocation result in the correspondence table 21 and updates the correspondence table 21 in regard to the allocation result (arrows A59 and A64).

The creator 12A allocates I/O address spaces to bridges #1 to #15 by repeatedly executing the same process with respect to the bridges #1 to #15. At this point of this, the I/O address spaces run out, and the creator 12A cannot allocate new I/O address spaces to a 16th bridge #16 (see FIG. 26).

When unallocated I/O addresses which can be allocated the bridges 71 run out and new I/O addresses cannot be allocated to the bridges 71 (arrow A66), the creator 12A performs the following process. That is, the creator 12A cancels address allocation to the bridge #1 which has already been registered in the correspondence table 21 (arrow A67), and allocates addresses 1000 to 1FFF to the new bridge #16 (arrow A69). Further, the creator 12A allocates I/O addresses 1020 to 102F and 1030 to 103F respectively to devices #31 and #32 connected to buses of the newly allocated bridge #16 (arrow A68). In this case, the creator 12A allocates the I/O addresses 1020 to 102F and 1030 to 103F of the devices #31 and #32 such that the I/O addresses 1020 to 102F and 1030 to 103F do not overlap the I/O addresses 1000 to 100F and 1010 to 101F of the devices #1 and #2 connected to the bridge #1 for which the address allocation has been canceled. Subsequently, the creator 12A updates the correspondence table 21 according to the above allocation cancellation or reallocation result (arrow A70).

Then, when a notification that creating the correspondence table 21 is finished is received from the creator 12A (arrows A71 and A72), the OS activates various applications (applications #1 and #2 in FIG. 31) (arrows A73 and A74). Each application makes an I/O access request using the library 14 for the I/O access. When the application #1 or #2 invokes the library 14 (arrows A75 and A81), the address allocation processor (allocator) 12B is invoked (arrows A76 and A82).

When being invoked by the library 14 and activated, the allocator 12B obtains a MUTEX, places a lock, and then performs retrieving in and refers to the correspondence table 21 using as a key the I/O addresses of the transfer destination device 81 of the I/O access request from the application. By this means, the allocator 12B obtains an entry of the transfer destination device 81 in the correspondence table 21, and checks a setting state of the current I/O addresses (arrows A77 and A83).

The allocator 12B refers to the obtained entry, and determines whether or not the I/O addresses are allocated to the bridge 71 connected with the access target device 81, i.e., whether or not “yes” is set to the address allocation filed of the entry. When the I/O addresses are allocated, I/O address spaces are adequately allocated to the bridges 71. Hence, a special process for the bridges 71 is not necessary, and an I/O access to the PCI device 81 is executed by making a normal I/O access (arrow A78). By this means, the application #1 which has issued an I/O access request obtains a desired result through the library 14 (arrows A79 and A80).

When the I/O access to the PCI device 81 is finished, the allocator 12B releases the lock. Consequently, another application which has been standing by so far can obtain a MUTEX and use the correspondence table 21.

By contrast with this, when I/O addresses are not allocated, the allocator 12B refers to the correspondence table 21, and obtains the bridge 71 (e.g., bridge #16) to which necessary I/O addresses are set as a cancellation target bridge (arrow A83). Subsequently, the allocator 12B cancels the I/O addresses 1000 to 1FFF of the cancellation target bridge #16 (arrow A84). Then, the allocator 12B allocates the I/O addresses to 1000 to 1FFF to the bridge 71 (e.g. #1) connected with the access target device 81 (arrow A85), and then updates the correspondence table 21 (arrow A86).

When I/O addresses are set to the bridge #1, the allocator 12B (library 14) accesses the device #1 or #2 (arrow A87). By this means, the application #2 which has issued the I/O access request obtains a desired result through the library 14 (arrows A88 and A89). Then, the allocator 12B releases the lock. Consequently, another application which has been standing by so far can obtain a MUTEX and use the correspondence table 21.

[3-3] Effect of Third Embodiment

Similar to the first embodiment and the second embodiment, the above computer system 1B according to the third embodiment executes an I/O access process with respect to the devices 81 when the allocator 12B cancels allocation of I/O address spaces to the bridges 71 and reallocates the I/O address spaces to the bridges 71 while referring to and updating the correspondence table 21 created by the creator 12A upon initialization of PCI buses. Consequently, even when the (e.g. 16 or more) bridges 71 the number of which exceeds a predetermined number are provided in the computer system 1A and therefore bridge addresses run out, it is possible to simultaneously use the bridges 71 the number of which exceeds the predetermined number.

Further, similar to the second embodiment, when I/O access requests from a plurality of applications to the devices 81 are made, the computer system 1B according to the third embodiment causes processes of applications which issue I/O access requests later to stand by until a lock based on a MUTEX is released. That is, even when an I/O access from another application to another device 81 is made while an I/O access request from one application to the device 81 is processed, a process related to the subsequent I/O access request stands by until the process related to the preceding I/O access request is finished. Consequently, it is possible to prevent the subsequent I/O access request from causing an unmatch in the correspondence table 21. In, for example, FIG. 31, a process (arrows A75 to A80) related to an I/O access request from the application #1 is finished, and a process (arrows A81 to A89) related to an I/O access request from the application #2 is executed.

[4] Others

The preferred embodiments of the present invention have been described above in detail. However, the present invention is not limited to the above specific embodiments, and can be variously modified and changed without departing from the spirit of the present invention.

In addition, cases where addresses are allocated to bridges in units of 4 KB and bridge addresses in I/O spaces run out at a point of time when the 15 bridges #1 to #15 are allocated have been described with the above embodiments. However, the present invention is not limited to these. Further, a case where 16 bridges and 32 devices are provided has been described as a specific example. However, the present invention is not limited to this.

The entirety or part of various functions of the information processing devices 1, 1A and 1B according to the first to third embodiments including the above PCI device/bridge correspondence table creation processor (creator) 12A and address allocation processor (allocator) 12B are realized by causing computers (including a CPU, an information processing device and various terminals) to execute predetermined programs.

The programs are provided by being recorded in computer-readable recording media such as flexible disks, CDs (CD-ROMs, CD-Rs, CD-RWs and the like), DVDs (DVD-ROMs, DVD-RAMS, DVD-Rs, DVD-RWs, DVD+Rs, DVD+RWs and the like) and blu-ray disks. In this case, the computer reads the program from the recording medium, transfers the program to an internal storage device or an external storage device and stores the program therein.

According to one embodiment, even when bridges the number of which exceeds a predetermined number are provided in an information processing device and therefore bridge addresses run out, it is possible to simultaneously use the bridges the number of which exceeds the predetermined number.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing device comprising:
a processor;
a plurality of devices; and
a plurality of bridges which connects the processor and the plurality of devices,
wherein the processor
creates a management table managing bridge addresses allocated to the plurality of bridges,
when an unallocated bridge address to be allocated to one bridge of the plurality of bridges runs out, cancels allocation of a first bridge address of the bridge addresses allocated to another bridge of the plurality of bridges, reallocates the cancelled first bridge address to the one bridge, and updates the management table in regard to the first bridge address cancelled and reallocated, and
when detecting one access to one device of the plurality of devices, refers to the management table, performs, based on the management table referred to, cancelling allocation of a second bridge address of the bridge addresses and reallocating the second bridge address to one or more of the plurality of bridges to enable execution of the one access, and updates the management table in regard to the second bridge address cancelled and reallocated.

2. The information processing device according to claim 1, wherein the processor
allocates at least one different device address to each of the plurality of devices
allocates one or more of the bridge addresses to each of the plurality of bridges,
creates the management table which associates and manages the device address, bridge identification information, one of the bridge addresses and allocation information, the bridge identification information specifying one of the plurality of bridges to which each of the plurality of devices belongs, each of the bridge addresses being allocated to the one of the plurality of bridges specified based on the bridge identification information, and the allocation information indicating whether or not each of the bridge addresses is valid in the one of the plurality of bridges specified based on the bridge identification information,
when the unallocated bridge address to be allocated to the one bridge runs out, cancels the allocation of the first bridge address allocated to the another bridge, and reallocates the cancelled first bridge address to the one bridge, and
sets that the allocation information of the another bridge in the management table is invalid and sets that the allocation information of the one bridge in the management table is valid.

3. The information processing device according to claim 2, wherein the processor
retrieves a first record from the management table, the first record including the device address of the one device,
when the allocation information in the first record is invalid, retrieves a second record from the management table, the second record including a same bridge address as the bridge address in the first record and including the allocation information which is set valid,
cancels allocation of the same bridge address to a second bridge associated with second bridge identification information of the second record different from first bridge identification information of the first record, and sets that the allocation information in the second record is invalid,
allocates the same bridge address to a first bridge associated with the first bridge identification information in the first record, and sets that the allocation information in the first record is valid.

4. The information processing device according to claim 1, wherein the processor
when creating the management table,
allocates the one or more of the bridge addresses to each of the plurality of bridges by setting a base address value and a limit address value to a base address register and a limit address register of configuration registers of each of the plurality of bridges, respectively, the base address value and the limit address value specifying a range of the one or more of the bridge addresses, and
cancels the allocation of the one or more of the bridge addresses to each of the plurality of bridges by setting 0 to the base address register and the limit address register.

5. The information processing device according to claim 1, wherein the processor
when detecting the one access to the one device,
allocates the one or more of the bridge addresses to each of the plurality of bridges by setting a base address value and a limit address value to a base address register and a limit address register of configuration registers of each of the plurality of bridges, respectively, the base address value and the limit address value specifying a range of the one or more of the bridge addresses, and
cancels the allocation of the one or more of the bridge addresses to each of the plurality of bridges by setting 0 to the base address register and the limit address register.

6. The information processing device according to claim 1, wherein
the processor constructs a plurality of virtual servers, and
when detecting, before finishing the execution of the one access after detecting the one access from one virtual server of the plurality of virtual servers, another access from another virtual server of the plurality of virtual servers, the processor causes a process of the another access to stand by until the execution of the one access is finished.

7. The information processing device according to claim 1, wherein a function of cancelling the allocation of the second bridge address and reallocating the second bridge address, and a function of updating the management table in regard to the second bridge address are included in a library of an OS (Operating System) in the processor, the library being used to access the one device of the plurality of devices.

8. A control method of controlling using a processor an information processing device which comprises the processor, a plurality of devices and a plurality of bridges which connects the processor and the plurality of devices,
wherein the processor
creates a management table managing bridge addresses allocated to the plurality of bridges,
when an unallocated bridge address to be allocated to one bridge of the plurality of bridges runs out, cancels allocation of a first bridge address of the bridge addresses allocated to another bridge of the plurality of bridges, reallocates the cancelled first bridge address to the one bridge, and updates the management table in regard to the first bridge address cancelled and reallocated, and
when detecting one access to one device of the plurality of devices, refers to the management table, performs, based on the management table referred to, cancelling allocation of a second bridge address of the bridge addresses and reallocating the second bridge address to one or more of the plurality of bridges to enable execution of the one access, and updates the management table in regard to the second bridge address cancelled and reallocated.

9. The control method of the information processing device according to claim 8, wherein the processor
allocates at least one different device address to each of the plurality of devices,
allocates one or more of the bridge addresses to each of the plurality of bridges,
creates the management table which associates and manages the device address, bridge identification information, one of the bridge addresses and allocation information, the bridge identification information specifying one of the plurality of bridges to which each of the plurality of devices belongs, each of the bridge addresses being allocated to the one of the plurality of bridges specified based on the bridge identification information, and the allocation information indicating whether or not each of the bridge addresses is valid in the one of the plurality of bridges specified based on the bridge identification information,
when the unallocated bridge address to be allocated to the one bridge runs out, cancels the allocation of the first bridge address allocated to the another bridge, and reallocates the cancelled first bridge address to the one bridge, and
sets that the allocation information of the another bridge in the management table is invalid and sets that the allocation information of the one bridge in the management table is valid.

10. The control method of the information processing device according to claim 9, wherein the processor
retrieves a first record from the management table, the first record including the device address of the one device,
when the allocation information in the first record is invalid, retrieves a second record from the management table, the second record including a same bridge address as the bridge address in the first record and including the allocation information which is set valid,
cancels allocation of the same bridge address to a second bridge associated with second bridge identification information of the second record different from first bridge identification information of the first record, and sets that the allocation information in the second record is invalid, and
allocates the same bridge address to a first bridge associated with the first bridge identification information in the first record, and sets that the allocation information in the first record is valid.

11. The control method of the information processing device according to claim 8, wherein the processor
when creating the management table,
allocates the one or more of the bridge addresses to each of the plurality of bridge by setting a base address value and a limit address value to a base address register and a limit address register of configuration registers of each of the plurality of bridges, respectively, the base address value and the limit address value specifying a range of the one or more of the bridge addresses, and
cancels the allocation of the one or more of the bridge addresses to each of the plurality of bridges by setting 0 to the base address register and the limit address register.

12. The control method of the information processing device according to claim 8, wherein the processor
when detecting the one access to the one device,
allocates the one or more of the bridge addresses to each of the plurality of bridge by setting a base address value and a limit address value to a base address register and a limit address register of configuration registers of each of the plurality of bridges, respectively, the base address value and the limit address value specifying a range of the one or more of the bridge addresses, and
cancels the allocation of the one or more of the bridge addresses to each of the plurality of bridges by setting 0 to the base address register and the limit address register.

13. A non-transitory computer-readable recording medium having recorded thereon a control program for causing a processor to execute a process for controlling an information processing device which comprises the processor, a plurality of devices, and a plurality of bridges which connects the processor and the plurality of devices, the process comprising:
creating a management table managing bridge addresses allocated to the plurality of bridges,
when an unallocated bridge address to be allocated to one bridge of the plurality of bridges runs out, cancelling allocation of a first bridge address of the bridge addresses allocated to another bridge of the plurality of bridges, reallocating the cancelled first bridge address to the one bridge, and updating the management table in regard to the first bridge address cancelled and reallocated, and
when detecting one access to one device of the plurality of devices, referring to the management table, performing, based on the management table referred to, cancelling allocation of a second bridge address of the bridge addresses and reallocating the second bridge address to one or more of the plurality of bridges to enable execution of the one access, and updating the management table in regard to the second bridge address cancelled and reallocated.

14. The non-transitory computer-readable recording medium according to claim 13, wherein the process further comprising:
allocating at least one different device address to each of the plurality of devices,
allocating one or more of the bridge addresses to each of the plurality of bridges
creating the management table which associates and manages the device address, bridge identification information, one of the bridge addresses and allocation information, the bridge identification information specifying one of the plurality of bridges to which each of the plurality of devices belongs, each of the bridge addresses being allocated to the one of the plurality of bridges specified based on the bridge identification information, and the allocation information indicating whether or not each of the bridge addresses is valid in the one of the plurality of bridges specified based on the bridge identification information,
when the unallocated bridge address to be allocated to the one bridge runs out, cancelling the allocation of the first bridge address allocated to the another bridge, and reallocating the cancelled first bridge address to the one bridge, and
setting that the allocation information of the another bridge in the management table is invalid and setting that the allocation information of the one bridge in the management table is valid.

15. The non-transitory computer-readable recording medium according to claim 14, wherein the process further comprising:
retrieving a first record from the management table, the first record including the device address of the one device,
when the allocation information in the first record is invalid, retrieving a second record from the management table, the second record including a same bridge address as the bridge address in the first record and including the allocation information which is set valid,
cancelling allocation of the same bridge address to a second bridge associated with second bridge identification information of the second record different from first bridge identification information of the first record, and setting that the allocation information in the second record is invalid, and
allocating the same bridge address to a first bridge associated with the first bridge identification information in the first record, and setting that the allocation information in the first record is valid.

16. The non-transitory computer-readable recording medium according to claim 13, wherein the process further comprising:
when creating the management table,
allocating the one or more of the bridge addresses to each of the plurality of bridges by setting a base address value and a limit address value to a base address register and a limit address register of configuration registers of each of the plurality of bridges, respectively, the base address value and the limit address value specifying a range of the one or more of the bridge addresses, and
cancelling the allocation of the one or more of the bridge addresses to each of the plurality of bridges by setting 0 to the base address register and the limit address register.

17. The non-transitory computer-readable recording medium according to claim 13, wherein the process further comprising:
when detecting the one access to the one device,
allocating the one or more of the bridge addresses to each of the plurality of bridges by setting a base address value and a limit address value to a base address register and a limit address register of configuration registers of each of the plurality of bridges, respectively, the base address value and the limit address value specifying a range of the one or more of the bridge addresses, and
cancelling the allocation of the one or more of the bridge addresses to each of the plurality of bridges by setting 0 to the base address register and the limit address register.
